(19) United States
(12) Patent Application Publication
(10) Pub. No.: US 2015/0194187 A1
(43) Pub. Date: Jul. 9, 2015

(54) TELESTRATOR SYSTEM

(71) Applicant: Microsoft Corporation, Redmond, WA (US)

(72) Inventors: Ryan Cleven, Vancouver (CA); Patrick Moody-Grigsby, Vancouver (CA); Wil Mozell, North Vancouver (CA); David Seymour, Vancouver (CA); Mark Findlay, Surrey (CA); Henry Watson, Vancouver (CA)

(73) Assignee: Microsoft Corporation, Redmond, WA (US)

(21) Appl. No.: 14/150,958

(22) Filed: Jan. 9, 2014

(51) Int. Cl. G11B 27/036; G06F 3/00; G06F 3/01; H04N 5/775; G11B 27/00; G06F 3/0484; G06F 3/0482; H04N 5/272; G10L 15/22

(52) U.S. Cl. CPC G11B 27/036; H04N 5/272; G06F 3/005; G06F 3/017; G10L 15/22; G11B 27/002; G06F 3/04845; G06F 3/04842; G06F 3/0482; H04N 5/775; G10L 2015/223

(57) ABSTRACT

A telestrator system running on a computing platform enables a video clip rendering on the platform to be telestrated with graphic objects including lines, arrows, or shapes that are drawn by a user using gestures that are captured by a camera system. The user can provide voice commentary while drawing on the video clip which is captured by a microphone in an audio track. A user interface (“UI”) is exposed that enables the user to scrub the video clip to a desired point at which to telestrate, provides drawing markers having different colors, and supports undo and clear capabilities to undo drawing strokes and clear all telestration drawings from the video clip. The telestrator system UI also exposes recording controls so that the user can record a video of the telestration session with the accompanying audio commentary which can then be saved and shared, for example, on a social network.

### BACKGROUND

A telestrator or video marker system enables a user to sketch lines and other graphic objects over moving or still images. Telestrator systems are commonly used in television broadcasting to provide diagrams to viewers in contexts such as weather forecasting and sports commentary. Telestrator systems can also be used in classroom and conference settings to enable video and still images to be annotated with sketches as a way to facilitate analysis and comprehension. Current telestrator systems typically employ a user interface such as a touchscreen on which the user draws with a finger or a stylus.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A telestrator system running on a computing platform such as a personal computer or multimedia console having a coupled camera system, audio capture device, and a display screen, enables a video clip rendering on the platform to be telestrated with graphic objects including lines, arrows, or shapes that are drawn by a user using gestures that are captured by the camera system. The user can provide voice commentary while drawing on the video clip which is captured by the audio capture device in an audio track. The telestrator system exposes a user interface (“UI”) that enables the user to scrub the video clip to a desired point at which to telestrate, provides drawing markers having different colors, and also supports undo and clear capabilities to undo drawing strokes and clear all telestration drawings from the video clip. The telestrator system UI also exposes recording controls so that the user can record a video of the telestration session with the accompanying audio commentary which can then be saved and shared, for example, on a social network.

In various illustrative examples of the telestrator system, the user gestures employed as inputs to control the telestration drawings include an open palm gesture, a closed fist gesture, and a lasso gesture (using a pointing hand pose). For example, the user can employ the open palm gesture to move a cursor around the screen and perform button pushes. The closed fist gesture may be used to scrub the video backwards or forwards along a timeline. When the user drops the pinky and ring fingers to form the lasso gesture, the cursor changes to a marker icon and the user's hand motions are used to control the marker path on the screen to draw lines and other objects. The drawing stops when the user opens the hand to show the open palm gesture. Shape recognition and smoothing techniques can be applied to the user's as-drawn input so that when the user's hand opens, an idealized line or shape is displayed. Voice commands captured by the audio capture device can be used to control the telestrator system, for example, to change marker colors, undo previous drawing strokes, and clear the telestrated drawings from the video clip.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 shows an illustrative computing environment in which the present telestrator system may be implemented;

FIG. 2 shows an illustrative taxonomy of capabilities that are exposed by the present telestrator system;

FIGS. 3-5 show pictorial views of an illustrative example of the present telestrator system in which a user interacts with a multimedia console in a typical home environment;

FIGS. 6-8 show illustrative gestures that a user may employ to control aspects of the present telestrator system;

FIGS. 9-11 and 15-26 show screenshots of a user interface at various points in time during an illustrative session using the present telestrator system;

FIGS. 12-14 show illustrative transformations of user drawing inputs into smoothed and/or idealized shapes and lines;

FIG. 27 is a flowchart of an illustrative method by which aspects of the present telestrator system may be implemented;

FIG. 28 shows a functional block diagram of an illustrative camera system that may be used in part to implement the present telestrator system;

FIG. 29 shows a functional block diagram of an illustrative multimedia console that may be used in part to implement the present telestrator system;

FIG. 30 is a simplified block diagram of an illustrative computer system such as a personal computer (“PC”) or server that may be used in part to implement the present telestrator system; and

FIG. 31 shows a block diagram of an illustrative computing platform that may be used in part to implement the present telestrator system.

Like reference numerals indicate like elements in the drawings. Elements are not drawn to scale unless otherwise indicated.

### DETAILED DESCRIPTION

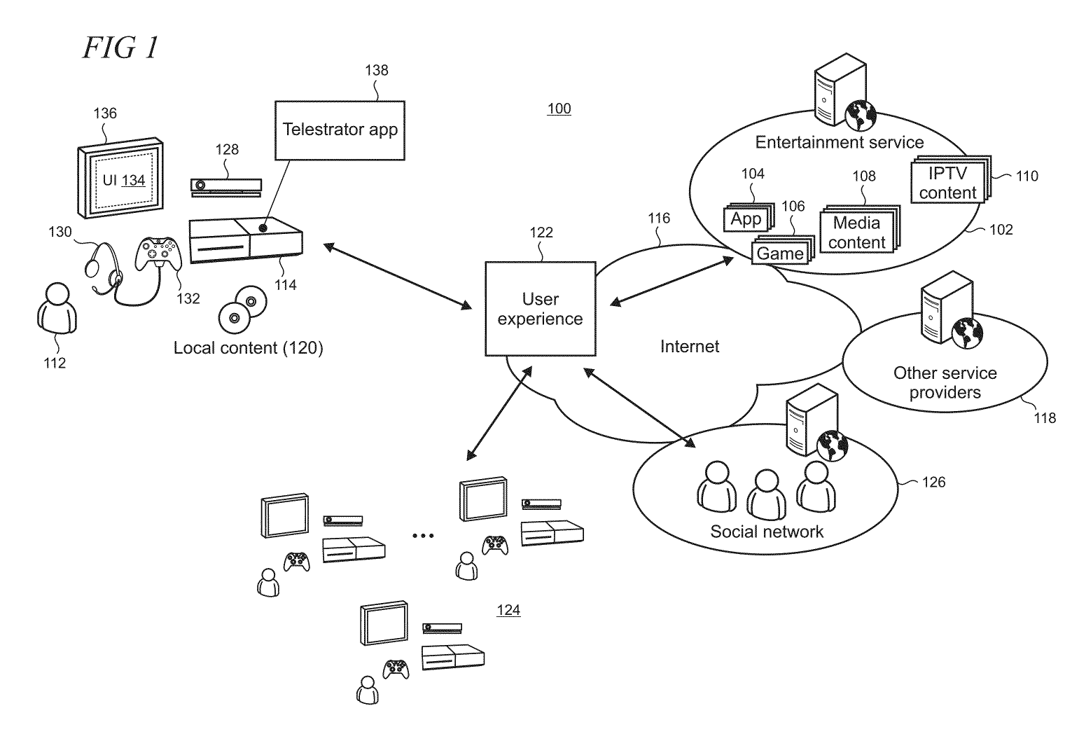

FIG. 1 shows an illustrative computing environment 100 in which the present telestrator system may be implemented. An entertainment service 102 typically can expose applications (“apps”) 104, games 106, and media content 108 such as television shows and movies, and streaming Internet Protocol Television (“IPTV”) content 110 to a user 112 of a multimedia console 114 over a network such as the Internet 116. Other service providers 118 that can provide various other services such as communication services, financial services, travel services, news and information services, etc. may also be in the environment 100.

Local content 120, including apps, games, and/or media content may also be utilized and/or consumed in order to provide a particular user experience 122 in the environment 100. In some cases the local content 120 is obtained from removable sources such as optical discs including DVDs (Digital Versatile Discs) and CDs (Compact Discs) while in others, the local content is downloaded from a remote source and saved locally. The user experience 122 may execute locally on the multimedia console 114, be hosted remotely by the entertainment service 102, or use a combination of local and remote execution in some cases using local or networked content/apps/games as appropriate. The user experience 122 may also be one in which multiple other players 124 with other computing devices can participate. In some implementations, a user experience can also be shared on a social network 126, as described in more detail below.

The user 112 can typically interact with the multimedia console 114 using a variety of different interface devices including a camera system 128 that can be used to sense visual commands, motions, and gestures, and a headset 130 or other type of microphone or audio capture device/system. In some cases a microphone and camera can be combined into a single device. The user 112 may also utilize a controller 132 to interact with the multimedia console 114. The controller 132 may include a variety of physical controls including joysticks, a directional pad (“D-pad”), and buttons. One or more triggers and/or bumpers (not shown) may also be incorporated into the controller 132. The user 112 will typically interact with a user interface 134 that is shown on a display device 136 such as a television or monitor.

It is emphasized that the number of controls utilized and the features and functionalities supported by the user controls implemented in the camera system 128, audio capture system, and controller 132 can vary from what is shown in FIG. 1 according to the needs of a particular implementation. In addition, in the description that follows various gestures, button presses, and control manipulations are described. It is noted that those actions are intended to be illustrative. For example, the user may actuate a particular button or control, or perform a particular gesture in order to prompt a system operating on the multimedia console 114 to perform a particular function or task. It will be appreciated that the particular mapping of controls to functions can vary from that described below according to the needs of a particular implementation. As used here, the term “system” encompasses the various software (including the software operating system (“OS”)), hardware, and firmware components that are instantiated on the multimedia console and its peripheral devices in support of various user experiences that are provided by the console.

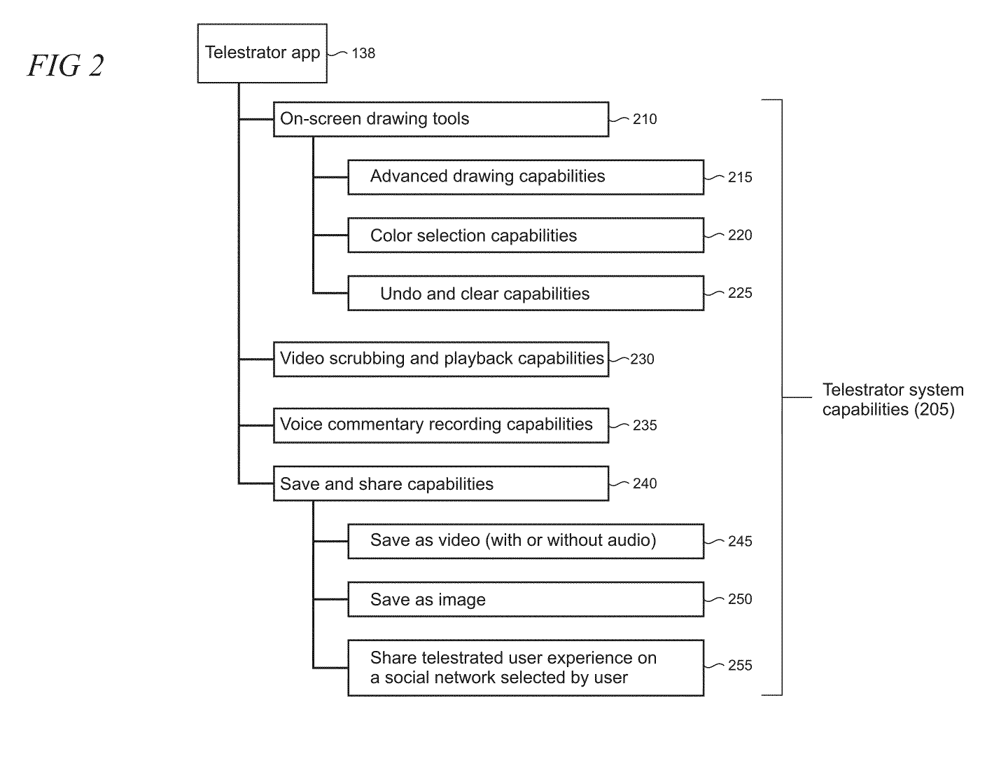

A telestrator app 138 executes on the multimedia console 114 in this illustrative example. As shown in FIG. 2, the telestrator app 138 is configured to expose a variety of features and capabilities 205 when operating as a part of a system running on the multimedia console 114. Some of the capabilities may execute simultaneously in some cases and not all of the capabilities need to be provided in a given telestrator system implementation. The telestrator system capabilities 205 include on-screen drawings tools 210 which include, in this illustrative example, advanced drawing capabilities 215, drawing color selection capabilities 220, and undo and clear capabilities 225. The telestrator system features also include video scrubbing and playback capabilities 230, voice commentary recording capabilities 235, and save and share capabilities 240. In this illustrative example, the save and share capabilities 240 include saving video with or without accompanying voice commentary audio 245, saving still images 250, and sharing a saved telestration session as a telestrated user experience on a user-selected social network 255.

Each of the telestrator system capabilities 205 are described in more detail in the illustrative examples below.

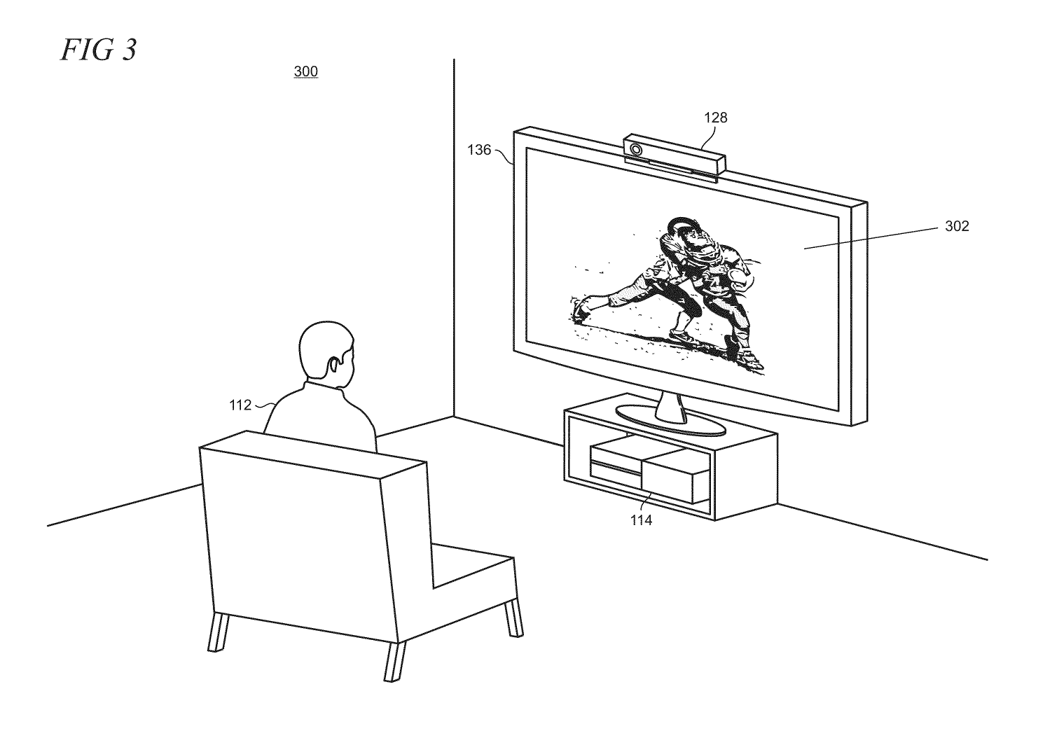

FIGS. 3-5 show pictorial views of an illustrative example of the present telestrator system in which the user 112 interacts with the multimedia console 114 in a typical home environment 300. In FIG. 3, the user 112 is watching a video clip 302 of a sporting event (e.g., an American football game) on the television 136. The video clip is streamed from an IPTV provider such as the entertainment service 102 shown in FIG. 1. IPTV content typically varies from conventional TV, for example by being available to consumers on-demand and by providing additional playback control features such as stop, pause, fast forward and back, and resume.

In addition to IPTV viewing, the multimedia console 114 is typically configured for running gaming and non-gaming applications using local and/or networked programming and content, playing pre-recorded multimedia such as optical discs including DVDs (Digital Versatile Discs) and CDs (Compact Discs), streaming multimedia (e.g., music and video) from a network, participating in social media, browsing the Internet and other networked media and content, or the like using a coupled audio/visual display such as the television 136. In some implementations, the multimedia console 114 may be configured to support conventional cable television (“CATV”) sources using, for example, an HDMI (High Definition Multimedia Interface) connection.

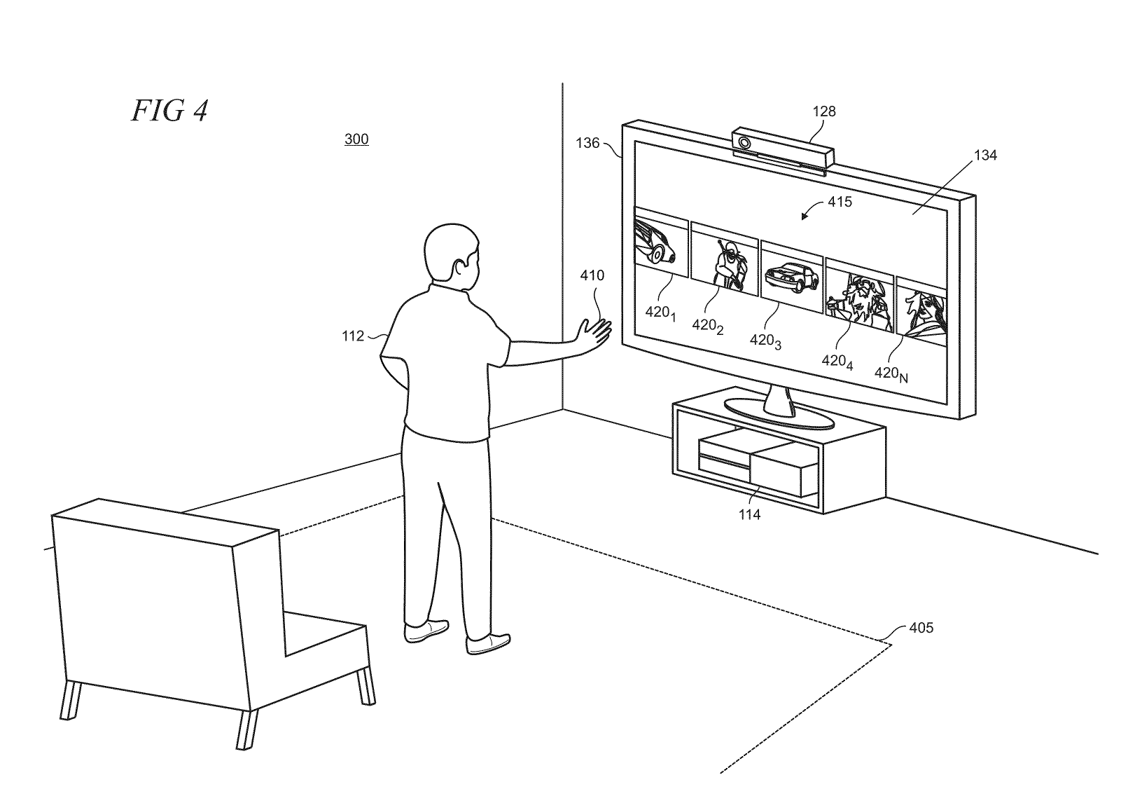

The multimedia console 114 is operatively coupled to the camera system 128 which may be implemented using one or more video cameras that are configured to visually monitor a physical space 405 that is indicated generally by the dashed line in FIG. 4 that is occupied by the user 112. As described below in more detail, camera system 128 is configured to capture, track, and analyze the movements and/or gestures of the user 112 so that they can be used as controls that may be employed to affect, for example, an app or an operating system running on the multimedia console 114. Various motions of the hands 410 or other body parts of the user 112 may correspond to common system-wide tasks such as selecting a game or other application from a main user interface.

For example as shown in FIG. 4, the user 112 can navigate among selectable objects 415 that include various icons 420_{1-N} that are shown on the UI 134 on the television 136, browse through items in a hierarchical menu, open a file, close a file, save a file, or the like. In addition, the user 112 may use movements and/or gestures to end, pause, or save a game, select a level, view high scores, communicate with a friend, etc. Virtually any controllable aspect of an operating system and/or application may be controlled by movements of the user 112. A full range of motion of the user 112 may be available, used, and analyzed in any suitable manner to interact with an application or operating system that executes on the multimedia console 114. While the user 112 is shown standing in FIG. 4, the camera system 128 can also recognize gestures that are performed while the user is seated.

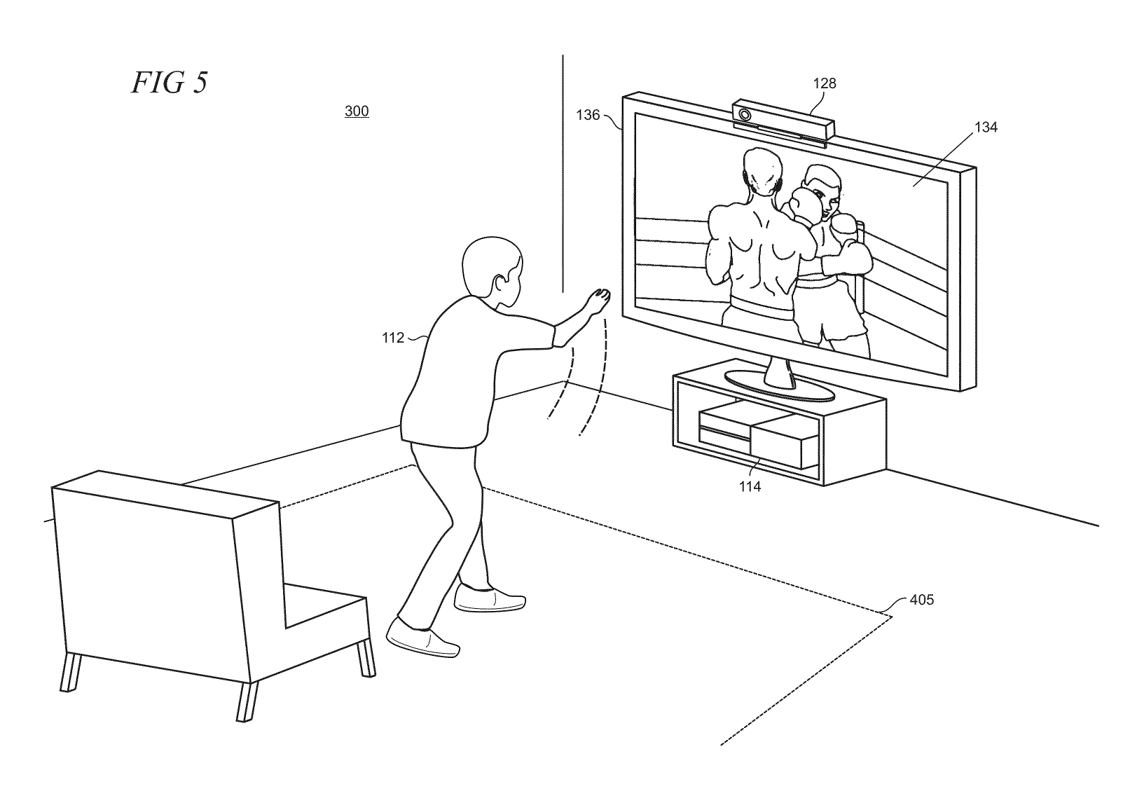

The camera system 128 can also be utilized to capture, track, and analyze movements by the user 112 to control gameplay as a gaming application executes on the multimedia console 114. For example, as shown in FIG. 5, a gaming application such as a boxing game employs the UI 134 to provide a visual representation of a boxing opponent to the user 112 as well as a visual representation of a player avatar that the user 112 may control with his or her movements. The user 112 may make movements (e.g., throwing a punch) in the physical space 405 to cause the player avatar to make a corresponding movement in the game space. Movements of the user 112 may be recognized and analyzed in the physical space 405 such that corresponding movements for game control of the player avatar in the game space are performed.

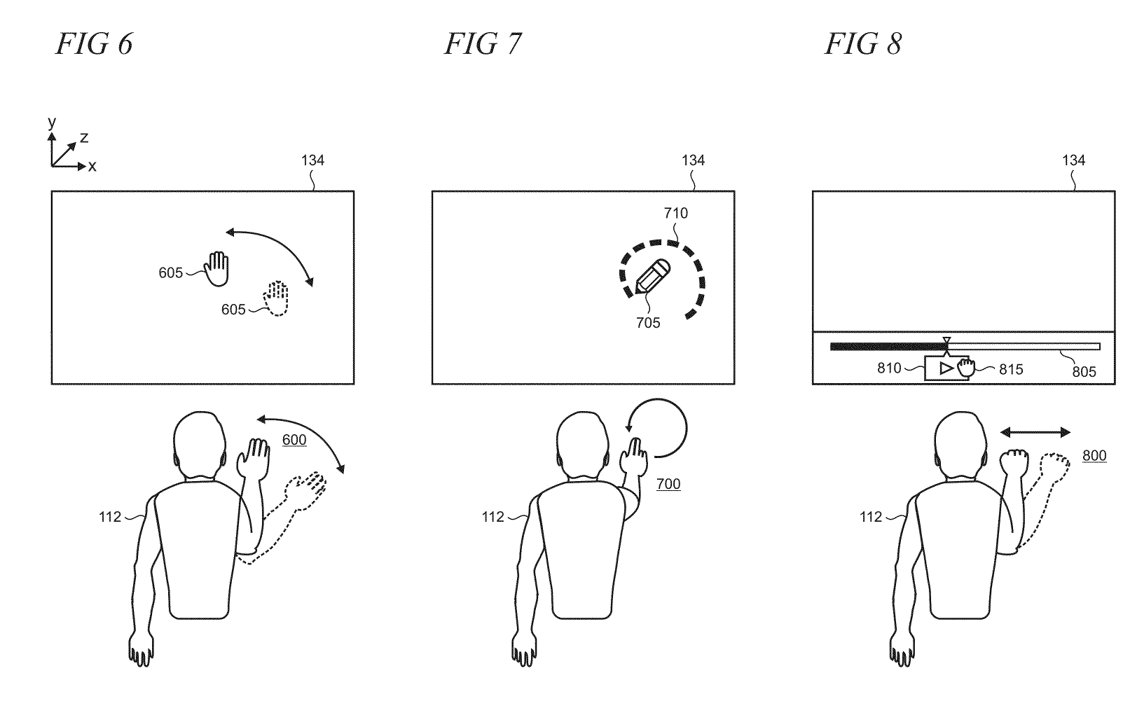

The present telestrator system uses several gestures to enable the user 112 to interact with the telestrator app 138 to telestrate portions of the IPTV video clip 302. As respectively shown in FIGS. 6-8, the gestures include an open palm gesture 600, a lasso gesture 700, and a closed fist gesture 800. When the telestrator app 138 is executing on the multimedia console 114, in what is termed “telestrator mode,” the user 112 can freely move a cursor 605 on the UI 134 using an open palm, as shown in FIG. 6. The open palm gesture 600 may be utilized along both the x and y axes to move the cursor 605 up and down on the UI 134. In addition, the open palm gesture 600 may be used along the z axis in order to perform presses of buttons displayed on the UI as described below.

When the user drops the pinky and ring finger to place the hand into a “lasso” pose, the cursor changes into a marker icon 705 and the user's hand movement is drawn as a dotted line 710 onto the UI 134, as shown in FIG. 7. Thus, the lasso pose is similar to pointing with the hand which is a natural and familiar gesture to users.

The user 112 can use the closed fist gesture 800 to scrub along a video timeline 805 in order to navigate to a desired point in the clip, as shown in FIG. 8. In this example, the user can drag the playhead 810 horizontally to the right or the left to go forward or backward in the video clip. As shown, the cursor changes to a closed fist shape 815. While the user's right hand is shown performing the gestures in FIGS. 6-8, it is noted that either hand may be used.

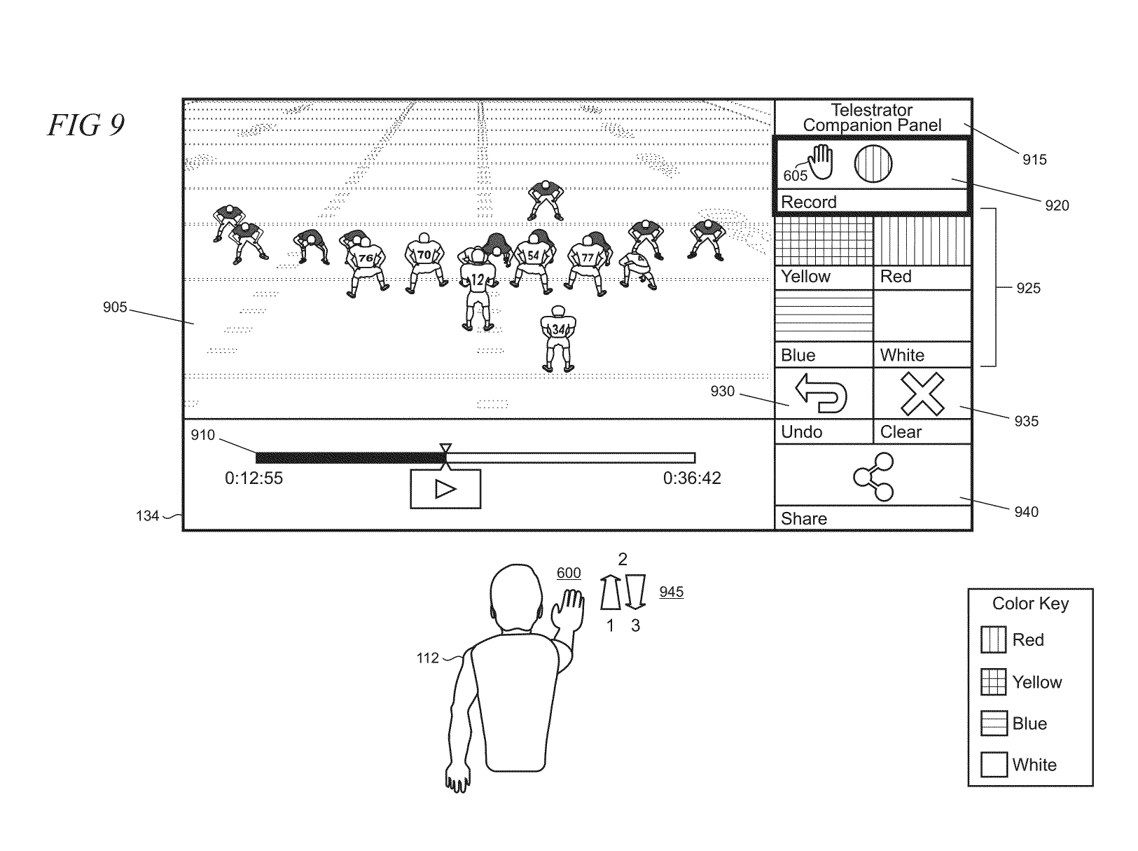

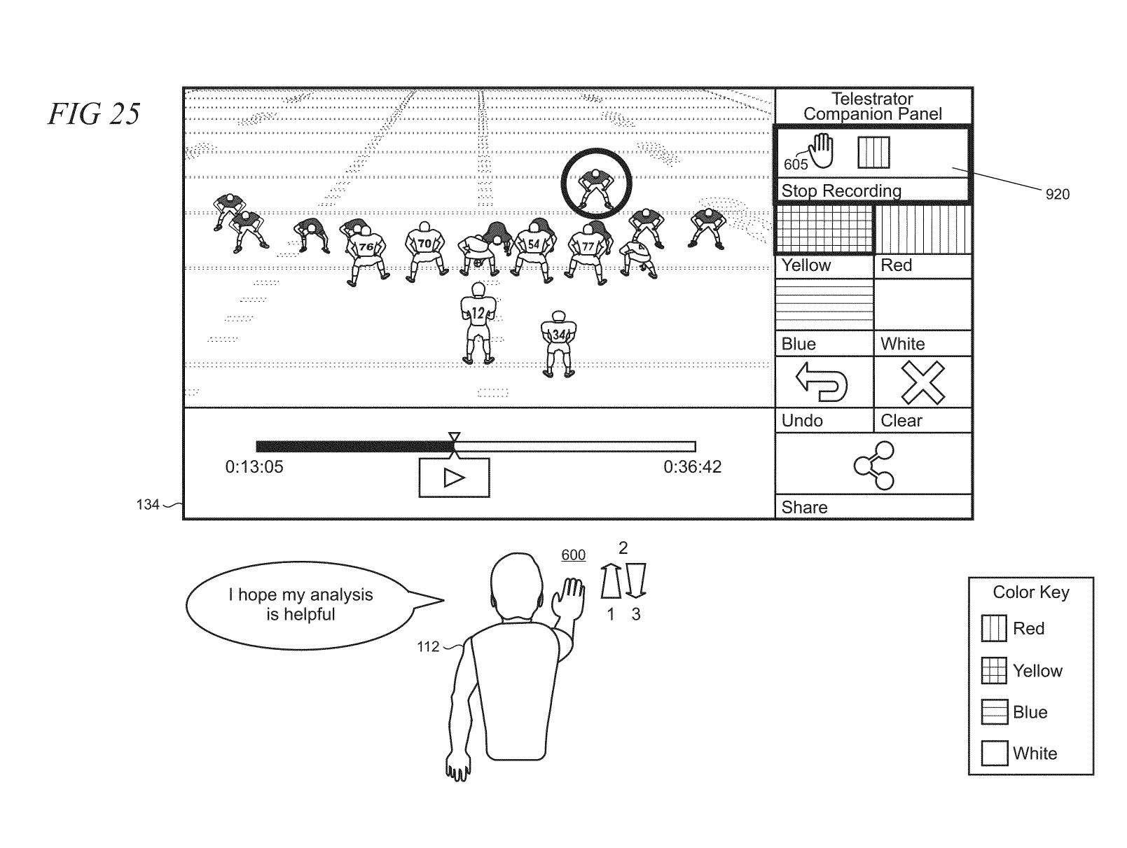

FIGS. 9-11 and 15-26 show screenshots of the UI 134 at various points in time during an illustrative session using the present telestrator system. It is emphasized that the screens shown in this example are intended to be illustrative and that the UI utilized in various implementations of the present telestrator system can vary from what is shown by content, format, and layout according to particular needs. In addition, in the screenshots shown in the drawings, the UIs shown have been simplified for clarity of exposition as black and white line drawings.

As shown in FIG. 9, the UI 134 includes a window 905 into which the video clip 302 renders. A video timeline 910 is located below the video window 905 and a telestrator companion panel 915 is located to the right of the window. In typical implementations, a control is provided in the particular app that the user 112 has selected to watch the video clip so that the user 112 can launch the telestrator companion panel 915. For example, a sports video watching app may be configured to support the telestrator mode as part of its user experience and the telestrator app 138 can expose an API (application programming interface) to the video app in order for it to call up the various telestrator system features 205 (FIG. 2). For example, a telestrator launch control may be placed next to the video transport controls exposed by the sports video app. The user 112 typically will pause the video and then activate the telestrator mode. Alternatively, the telestrator mode may be configured to launch from a control shown on a home screen, app launcher, or other location supported on the UI of the multimedia console 114.

The telestrator companion panel 915 includes a record control button 920 that enables the user 112 to record and save a telestration session. In this illustrative example, the user 112 can draw in telestrator mode using four different colors including yellow, red, blue, and white. The colors are selected using the color selection buttons 925. In addition, the user 112 can use a voice command (e.g., by saying “red”) to select a drawing color. An undo button 930 may be used to erase the last stroke of a drawing, and the clear button 935 removes all telestrator drawings from the UI 134 when invoked. A share button 940 may be used to open a sharing menu, window, or dialogue to enable the user to share a saved telestration session with the user's social graph (e.g., friends, family, colleagues, etc.) on a social network. The functionalities of the undo, clear, and share buttons may also be invoked using voice commands (e.g., by saying “undo,” “clear,” and “share” or their non-English language equivalents) as described in more detail below.

With the video paused at a desired point of interest, the user 112 uses the open palm gesture to move the cursor 605 to the record control button 920 and implement a press by hand motions in the z direction as indicated by the arrows 945. Typically, the user will telestrate over a still image from the video clip, but in some cases the telestration can be performed over a segment of motion video. For example, the video clip may include live action that is appropriate for telestrating or include slow-motion footage that the user may wish to draw on.

When a button is pressed on the telestrator companion panel its border is highlighted on the UI 134 as shown. The record control button press starts a video recording of the telestration session that shows lines being drawn over the video clip 302 in real time and also includes an audio track of commentary captured by the microphone in the headset or camera system. The recorded video of the telestration session is typically locally saved on the multimedia console 114 and can be shared later on a social network or stored/uploaded to another cloud-based service, for example.

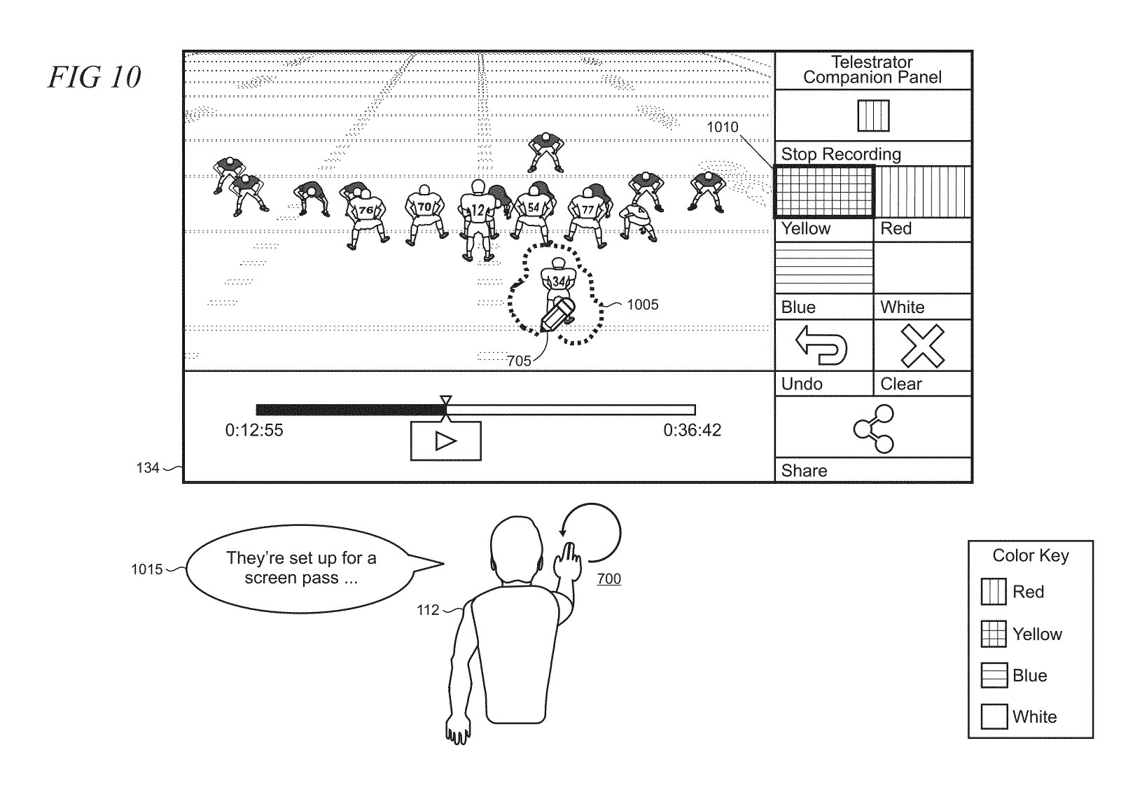

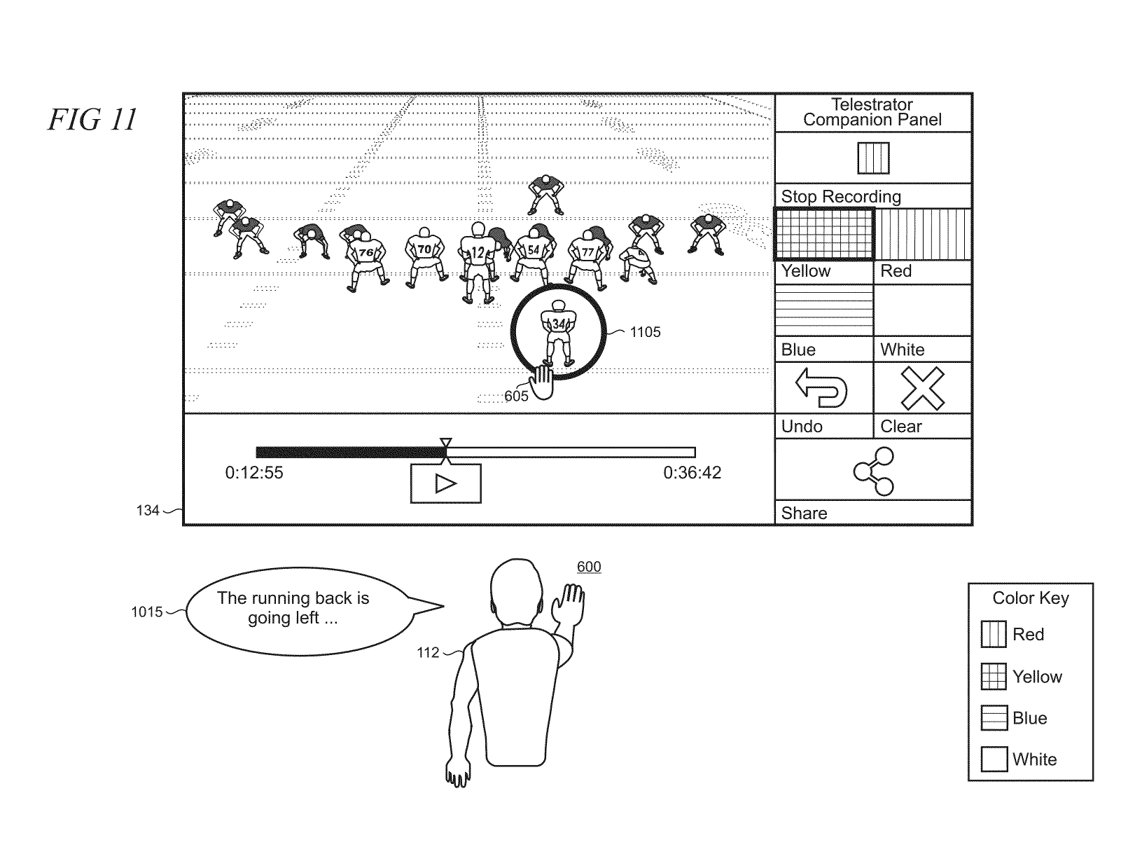

FIG. 10 shows the user 112 using the lasso gesture 700 to draw a line 1005 around one of the players in the video. To begin drawing a line, the user 112 first moves the cursor to the point on the UI 134 where the line starts and then drops the pinky and ring finger to place the hand into the lasso pose and begin drawing. When using the lasso gesture, the cursor changes to the marker icon 705 and the user's hand movements are drawn on the UI 134 as a dotted line. In this illustrative example, the line color is yellow by default (the color is not indicated in the black and white drawing) which is indicated to the user by a highlighted border 1010 around the yellow color section button. The user's spoken comments (indicated by reference numeral 1015) made while telstrating the video clip are captured in an audio track.

FIG. 11 shows that when the user 112 returns to the open palm gesture 600, the drawing of the line stops and the marker icon reverts back to the normal cursor 605. An example of the advanced drawing functionalities 215 (FIG. 2) is also shown in FIG. 11. The dotted line that the user draws as an irregular shape (FIG. 10) is transformed by the telestrator app into a perfect circle 1105 using a solid yellow line. When implementing the advanced drawing functionalities, the telestrator app interprets the user's rough drawing input to predict the user's intent. Such interpretation can include interpolation of points along the curve of the user's drawn line in order to capture the user's intended line shape and drawing size.

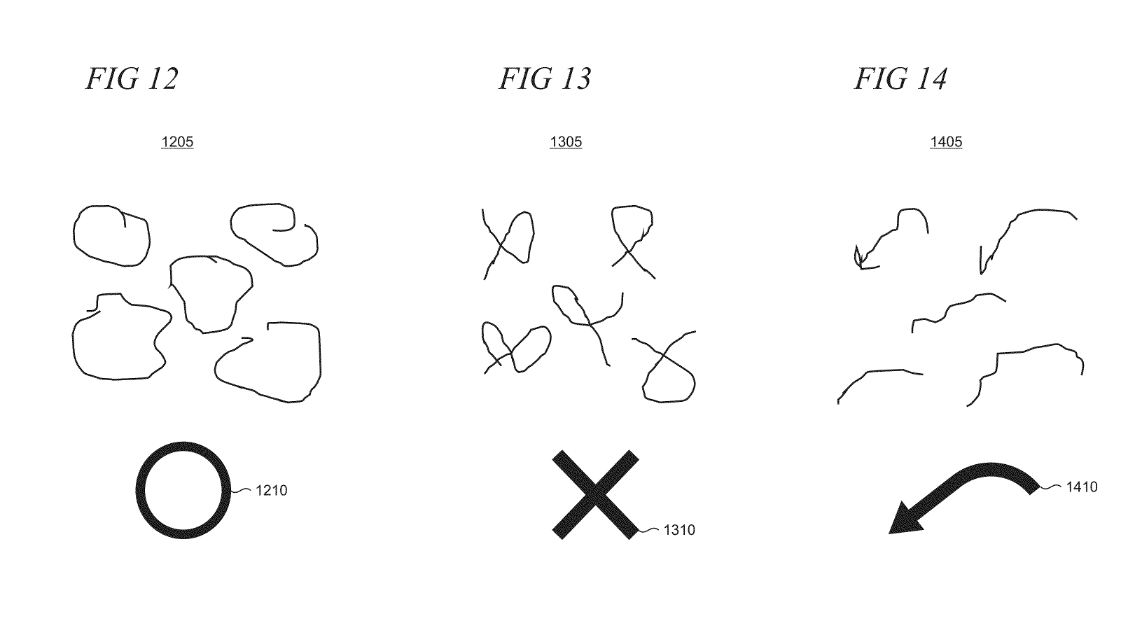

As shown in FIGS. 12-14, various types of imperfect input from the user can be transformed by the telestrator app 138 into more idealized shapes using shape recognition and smoothing techniques. For example, FIG. 12 shows illustrative user inputs 1205 that the telestrator app can transform into a circle 1210. FIG. 13 shows illustrative user inputs 1305 that the telestrator app can transform into an “X” shape 1310. FIG. 14 shows illustrative user inputs 1405 that the telestrator app can transform into a smoothed line 1410 having an arrowhead where the amount of smoothing utilized can vary by implementation. It is noted that the advanced drawing functionalities can be optionally utilized in some implementations and that in some cases the functionalities may be configured to be user-enabled and disabled so that the user 112 can decide whether to show idealized line shapes or the lines as actually drawn. In some cases, the amount of smoothing applied to the user's input can be adjusted by the user. Such user control of the advanced drawing functionalities may be exposed by the telestrator app 138 in a preferences menu, window, or dialogue on the UI in some cases.

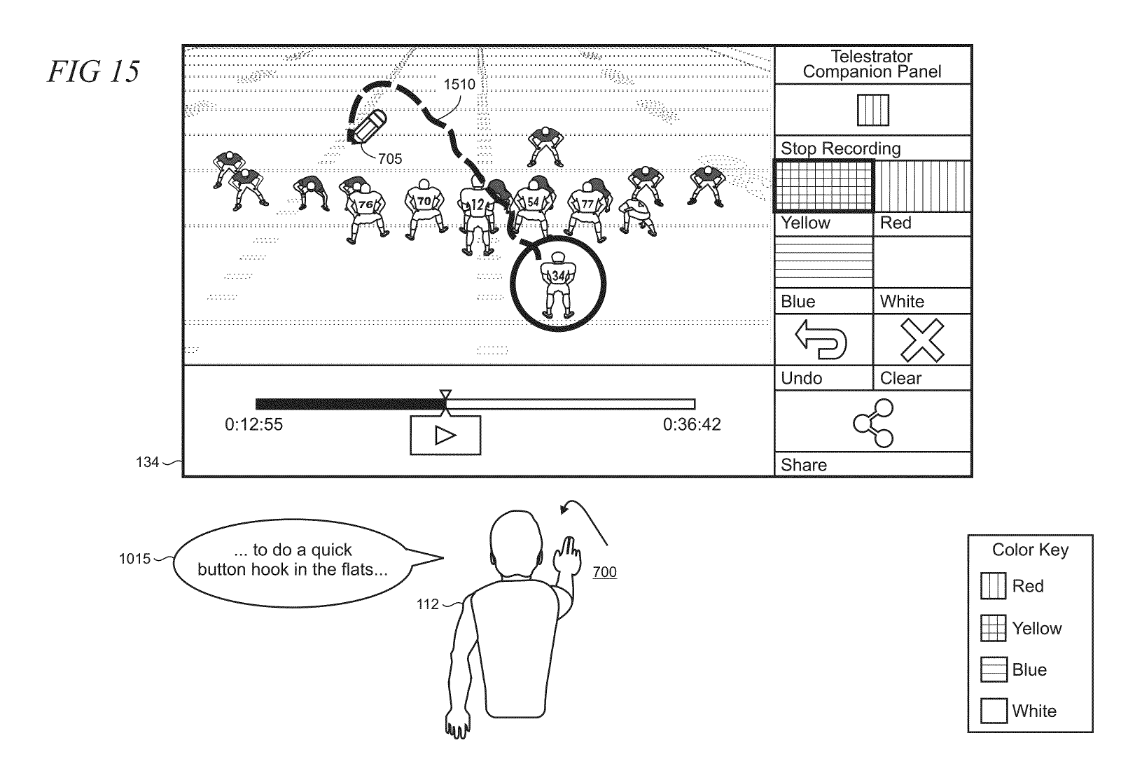

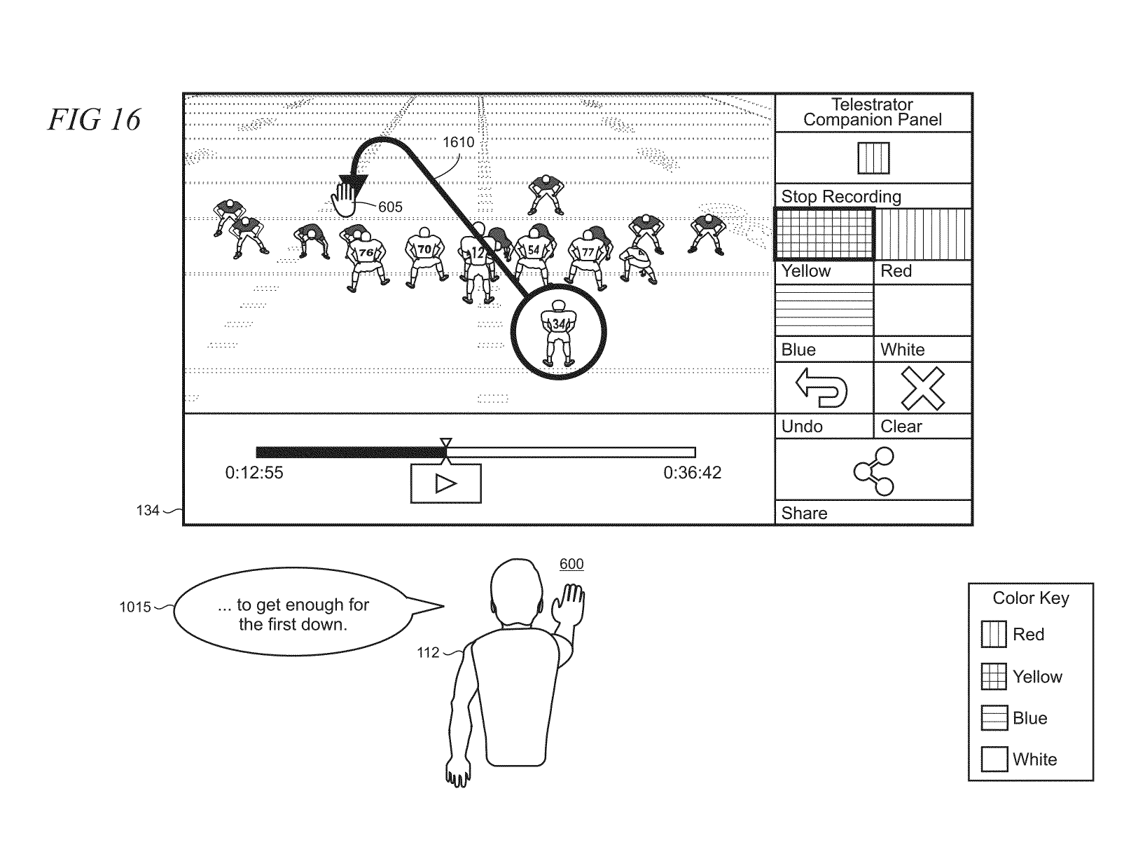

FIG. 15 shows the user 112 using the lasso gesture 700 to draw a line 1510 to illustrate the runner's route while continuing his commentary 1015. When the user 112 opens his palm to make the palm gesture 600, the roughly drawn line is transformed by the telestrator app 138 into a smoothed line 1610 that closely matches the user's intended route, as shown in FIG. 16.

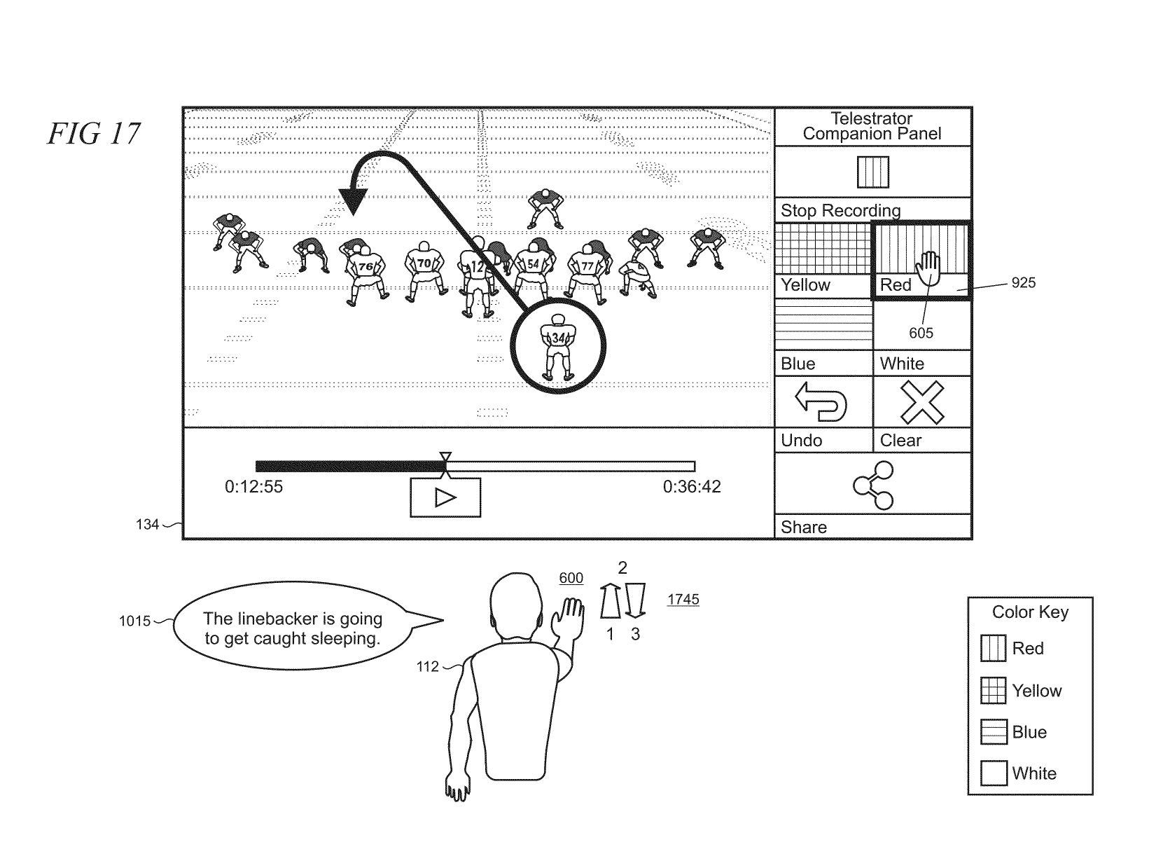

The user 112 next wants to change the marker color from the default yellow. As shown in FIG. 17, the user 112 moves the cursor 605 to the red color selection button 925 and performs a button push by moving his palm back and forth in the z direction (as indicated by reference numeral 1745). The user also continues his commentary 1015 that is captured in the audio track.

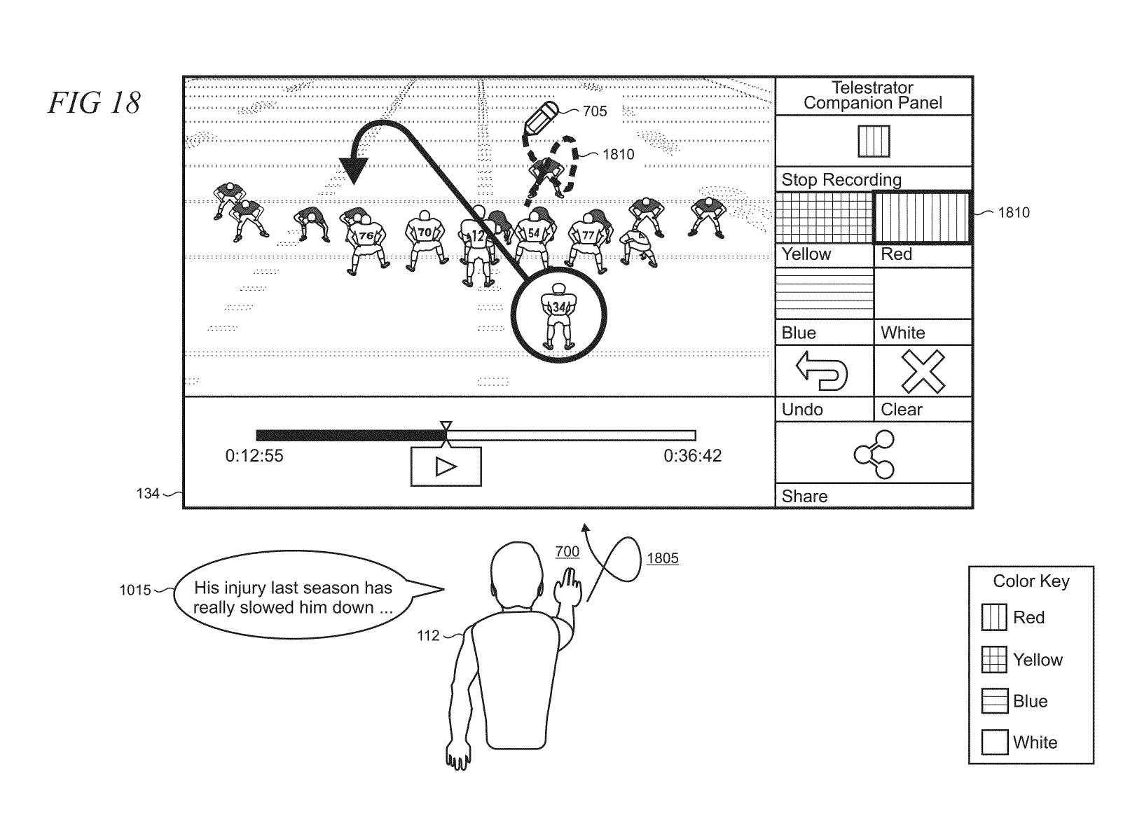

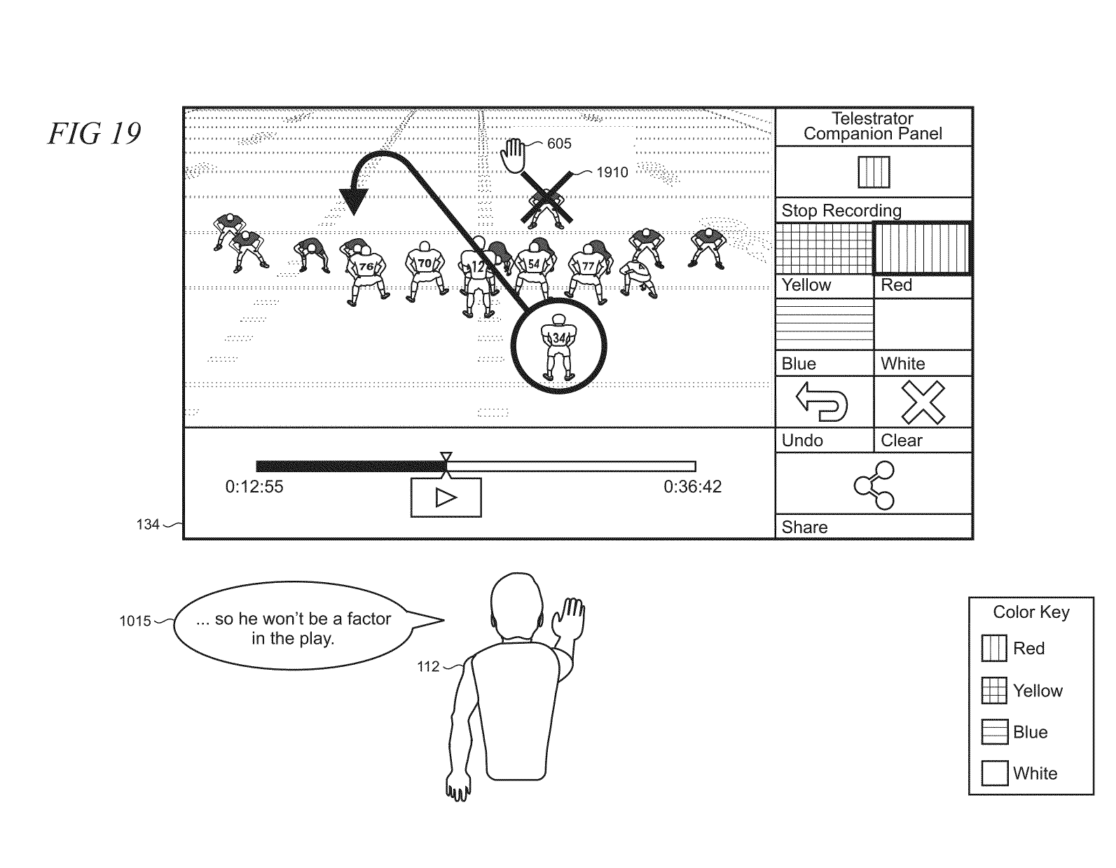

FIG. 18 shows the user 112 marking an “X” on one of the defensive players using the lasso gesture 700 by drawing a continuous line in a looping motion 1805. The line 1810 is displayed on the UI 134 as a red dotted line (the red color is not indicated in drawing) and the border 1810 of the red color selection button is highlighted to show the user that the marker color is red. As shown in FIG. 19, while continuing his commentary when the user 112 opens his palm to make the palm gesture 600, the roughly drawn line is transformed by the telestrator app 138 into an ideally-shaped “X” 1910 that is displayed on the UI 134 in red.

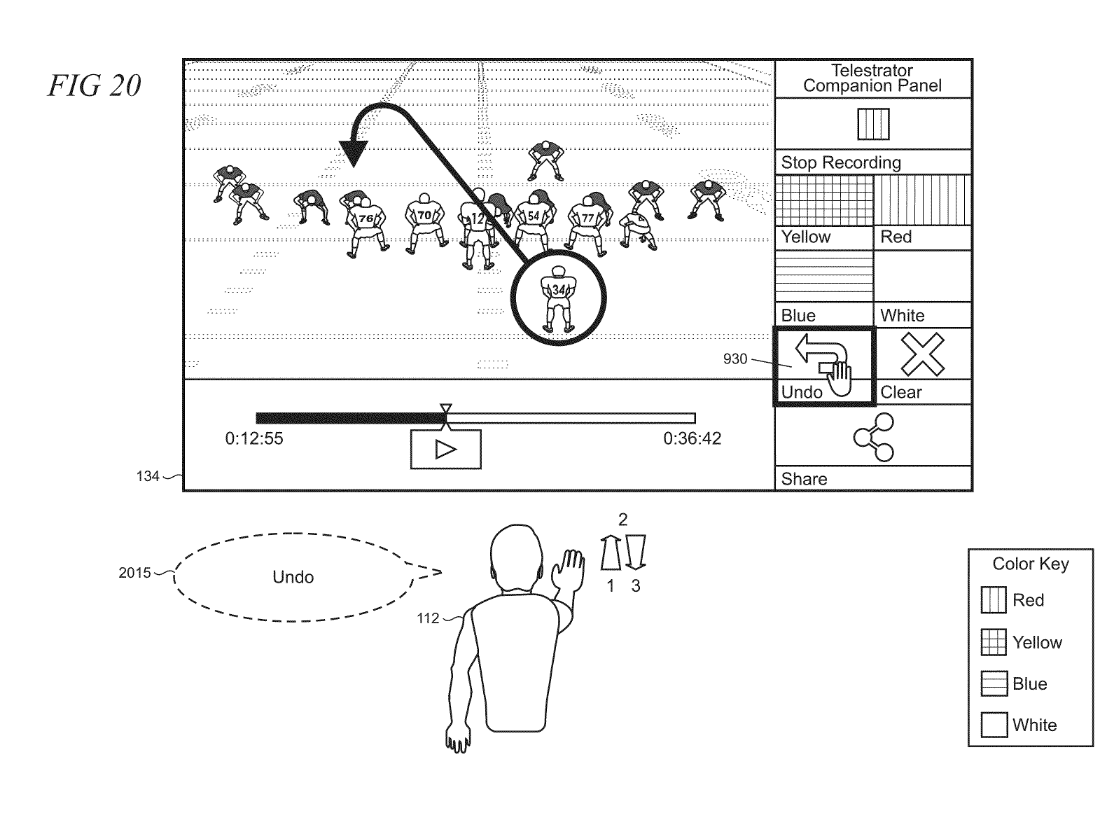

FIG. 20 shows the user 112 pressing the undo button 930 using the open palm gesture 600 and motions in the z direction. The undo button is configured to remove the last marker stroke when implemented. In this case, the “X” on the defensive player is removed from the UI 134. As noted above, an “undo” voice command, as shown using the dashed line 2015, may also be used to effectuate the undo action. In addition, the undo functionality may be configured to be used repeatedly so that the next to last marker stroke is removed, and so on from last stroke to first, with each successive invocation.

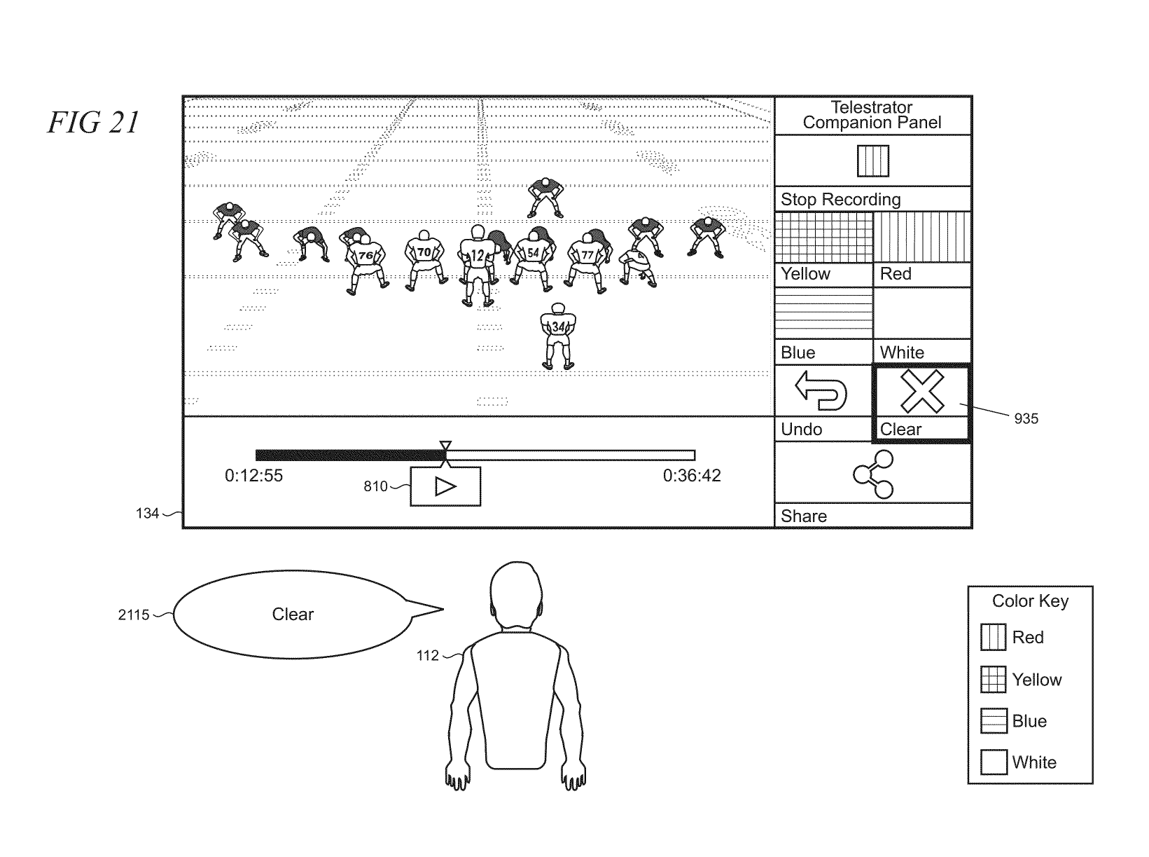

If the user 112 says the voice command “clear,” as indicated by reference numeral 2115 in FIG. 21, then the functionality of the clear button 935 is invoked. This button manipulation causes the telestrator app 138 to clear the entire drawing from the UI. In addition to using the voice command, the user 112 can move the cursor to the clear button 935 using the open palm gesture 600 and button press motions to clear the drawing from the UI 134.

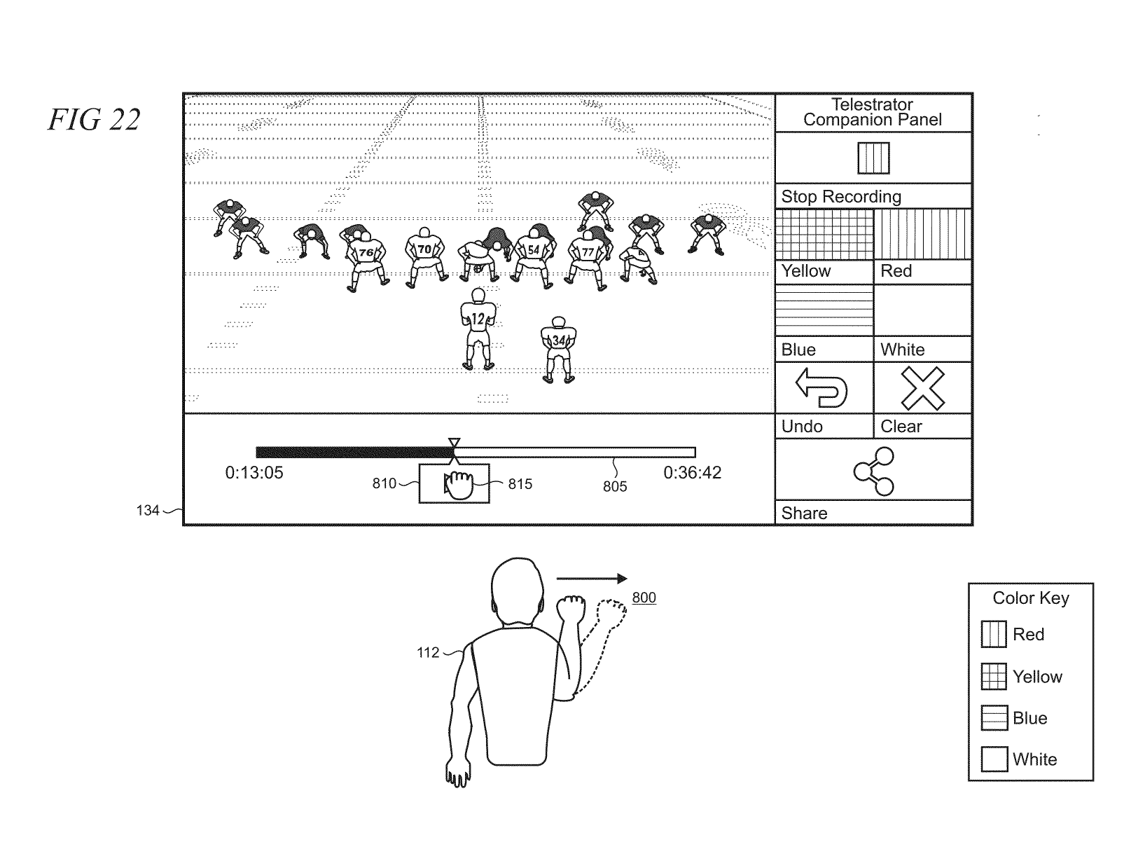

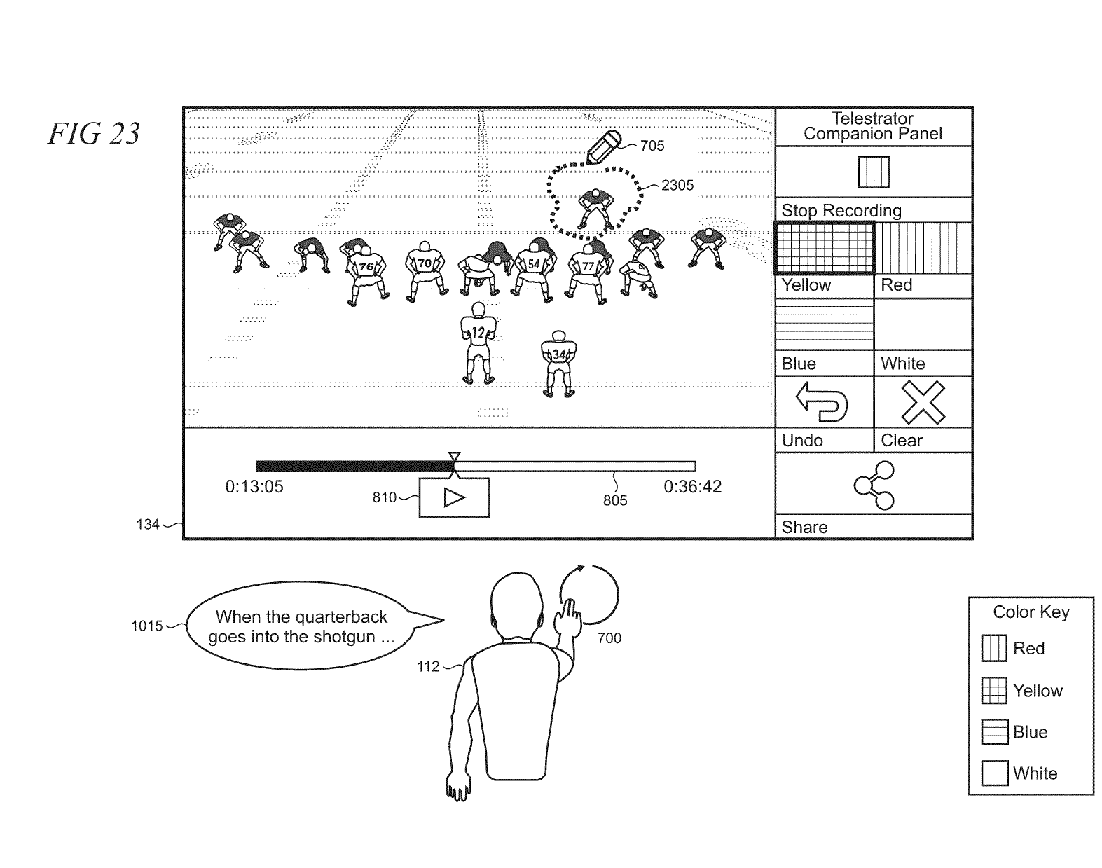

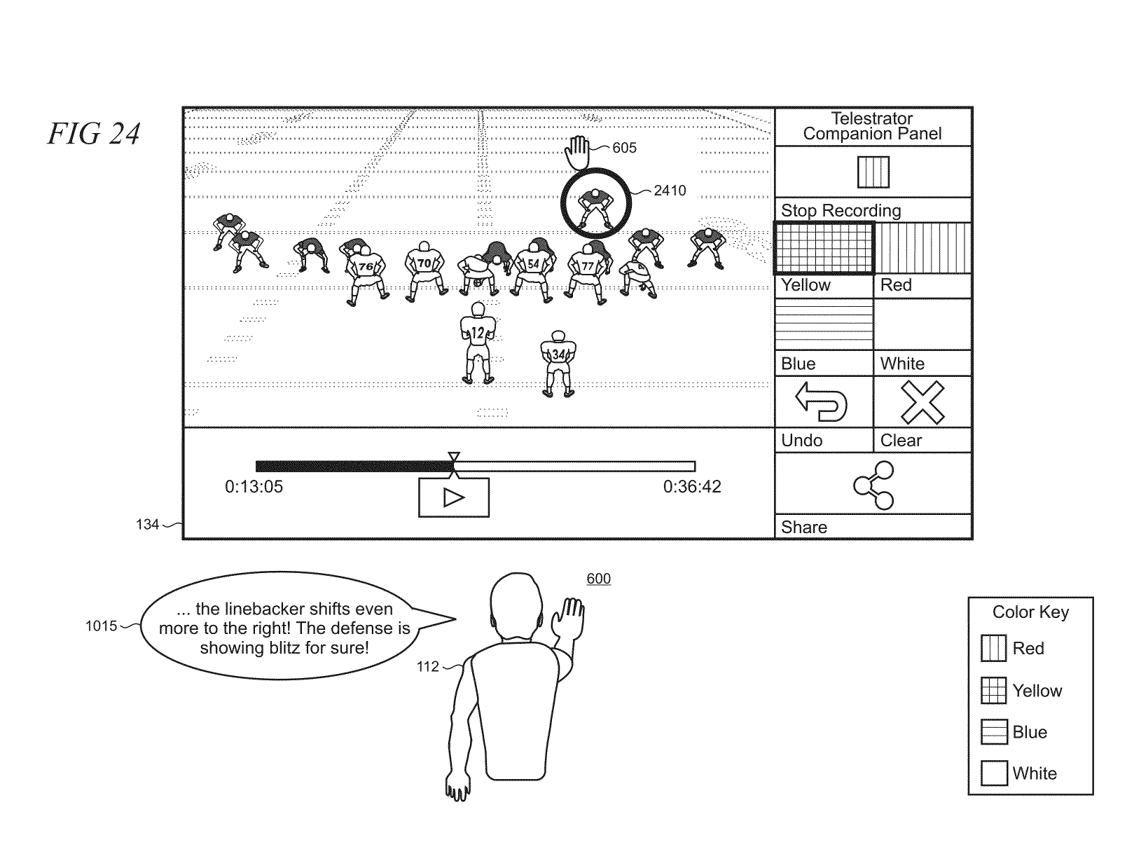

The user 112 can scrub the video clip by first moving the cursor to the video playhead 810 using the open palm gesture. Then, as shown in FIG. 22, using the closed fist gesture 800, the user 112 can drag the video playhead 810 to the left to go back through the video timeline 805, or drag it to the right to advance through the timeline. In this illustrative example, the user 112 has advanced the video clip a few seconds forward in time to make additional telestrations. In FIG. 23, the user 112 uses the lasso gesture 700 to draw a circle 2305 around a defensive player using a yellow marker while making additional commentary 1015 for the audio track. As before, when the user 112 opens his palm to make the open palm gesture 600, the roughly drawn line is transformed by the telestrator app 138 into a perfect circle 2410 that is displayed on the UI 134 in yellow, as shown in FIG. 24.

When the user 112 is finished with his analysis and wishes to stop telestrating, he can use the open palm gesture 600 to move the cursor 605 to the recording control button and use button press motions to stop the recording of the telestration session. As noted above, the recorded video of the telestration session and the accompanying audio track of commentary is typically saved locally on the multimedia console 114, although it may also be remotely saved (e.g., in the cloud or on a remote server or other computing platform or device), or be saved using a combination of local and remote storage. In some cases the telestrator app 138 can expose saving options to the user 112 or the user can select how recorded telestration sessions are saved in a preferences menu, window, or dialogue. For example, the recorded session may be saved as a telestrated user experience in the form of a video and/or one or more still images (with or without the accompanying audio track).

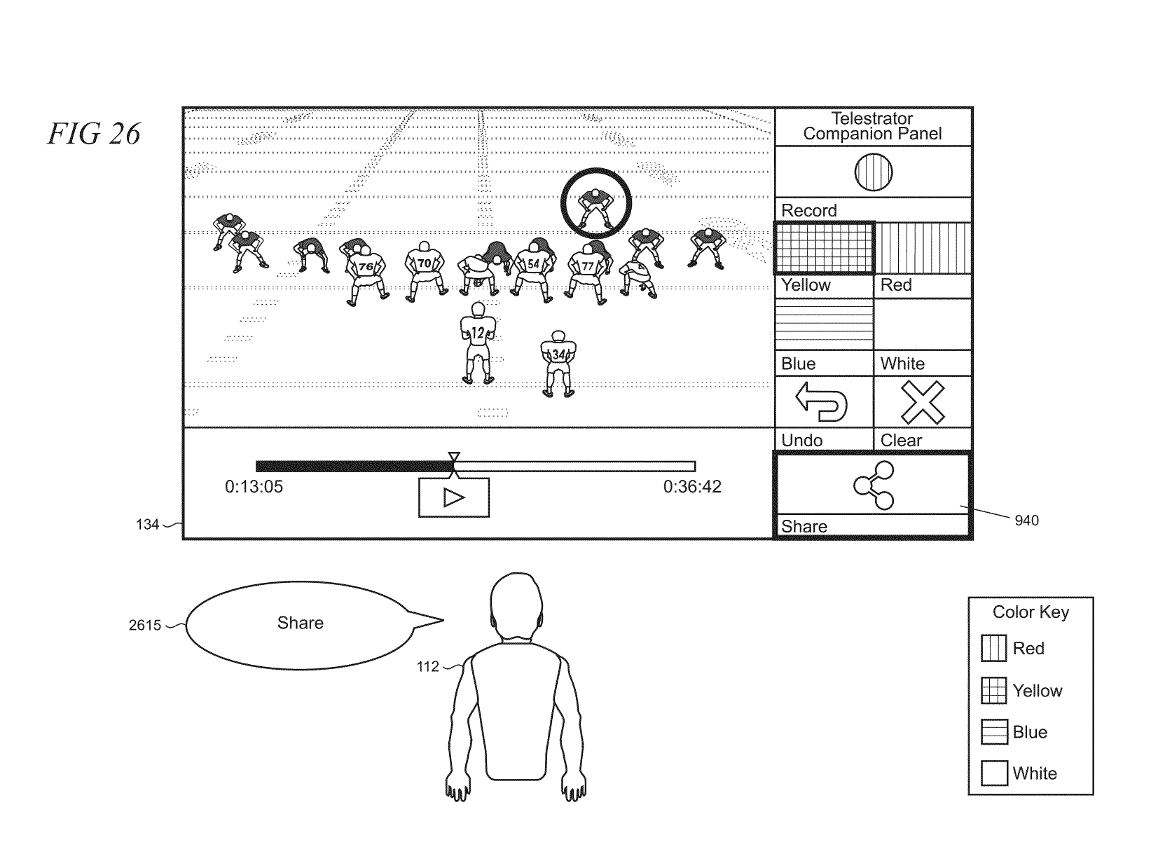

FIG. 26 shows the user 112 saying the voice command “share,” as indicated by reference numeral 2615, in order to invoke functionality of the share button 940 which brings up the telestrator app's sharing menu (not shown in the drawings). In addition to using the voice command, the user 112 can move the cursor to the share button 940 using the open palm gesture 600 and button press motions in order to bring up the sharing menu. The sharing menu operates in a conventional manner to enable the user to select people with whom a telestrated user experience is shared. For example, the sharing menu can provide various options for the user to select which saved telestrated user experiences are shared, with whom, and on which social networks. In some cases, compression routines can be applied to a telestrated user experience in order to reduce its file size prior to it being shared.

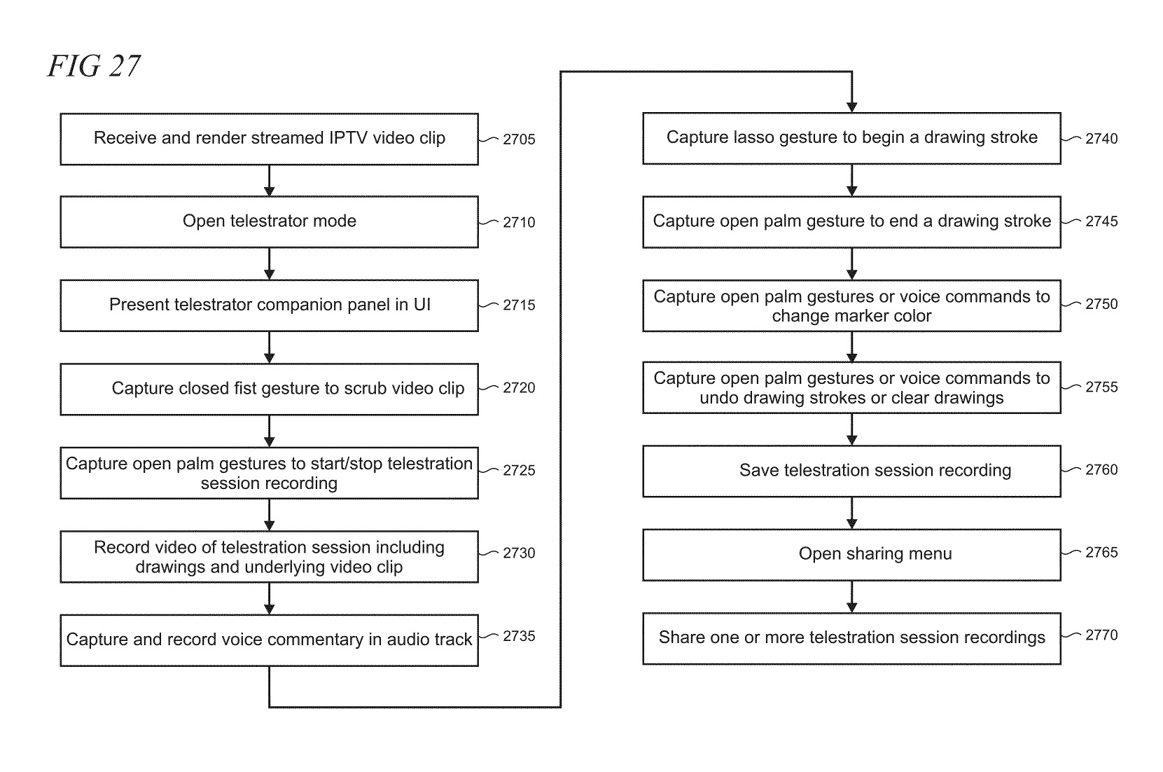

FIG. 27 is a flowchart of an illustrative method 2700 by which various aspects of the present telestrator system may be implemented. Unless specifically stated, the methods or steps shown in the flowchart and described below are not constrained to a particular order or sequence. In addition, some of the methods or steps thereof can occur or be performed concurrently and not all the methods or steps have to be performed in a given implementation depending on the requirements of such implementation. Some methods or steps may also be optionally utilized.

In step 2705, the multimedia console 114 receives and renders an IPTV video clip from a remote source such as the entertainment service 102 (FIG. 1). Alternatively, the video clip can be retrieved from a local source. In step 2710, the user 112 invokes the telestrator mode from within another app such as a video watching or media content consumption app, or by launching the telestrator app 138 from a launch location supported on the media console 114. At step 2715, the telestrator app 138 will present the telestrator companion panel 915 (FIG. 9) in the UI 134. At step 2720, the camera system 128 captures a closed fist gesture 800 from the user 112 to scrub the video clip to a desired point along the video timeline.

At step, 2725, the camera system 128 will capture open palm gestures 600 and presses from the user 112 to operate the recording control 920 exposed on the telestrator companion panel 915. At step 2730, when the recording control is pressed to start a recording, the telestrator app 138 records a video of the telestration session including the user's drawings as they are drawn in real time and the underlying image or motion video from the clip. At step 2735, the user's voice commentary is captured by a microphone and recorded and saved as an accompanying audio track.

At step 2740, the camera system 128 captures the user's lasso gesture 700 to begin a drawing stroke. When the user 112 opens his hand to show the open palm gesture 600, the drawing stroke ends at step 2745. At step 2750, the user 112 can use open palm gestures and button presses or voice commands to change the marker color (as noted above, the default marker color is yellow in one particular illustrative embodiment). At step, 2755, the camera system 128 can capture open palm gestures 600 and button presses or voice commands to undo drawing strokes or clear telestration drawings from the UI. At step 2760, the video recording of the telestration session is saved, either locally, remotely, or using some combination of local and remote storage.

At step 2765, the user 112 can use open palm gestures 600 and button presses or voice commands to open a sharing menu in order to share video recordings of telestration sessions over a network at step 2770. As noted above, the sharing menu will typically provide options for the user to select which videos are shared, which members of the user's social graph they are shared with, and which social networks are utilized for the sharing.

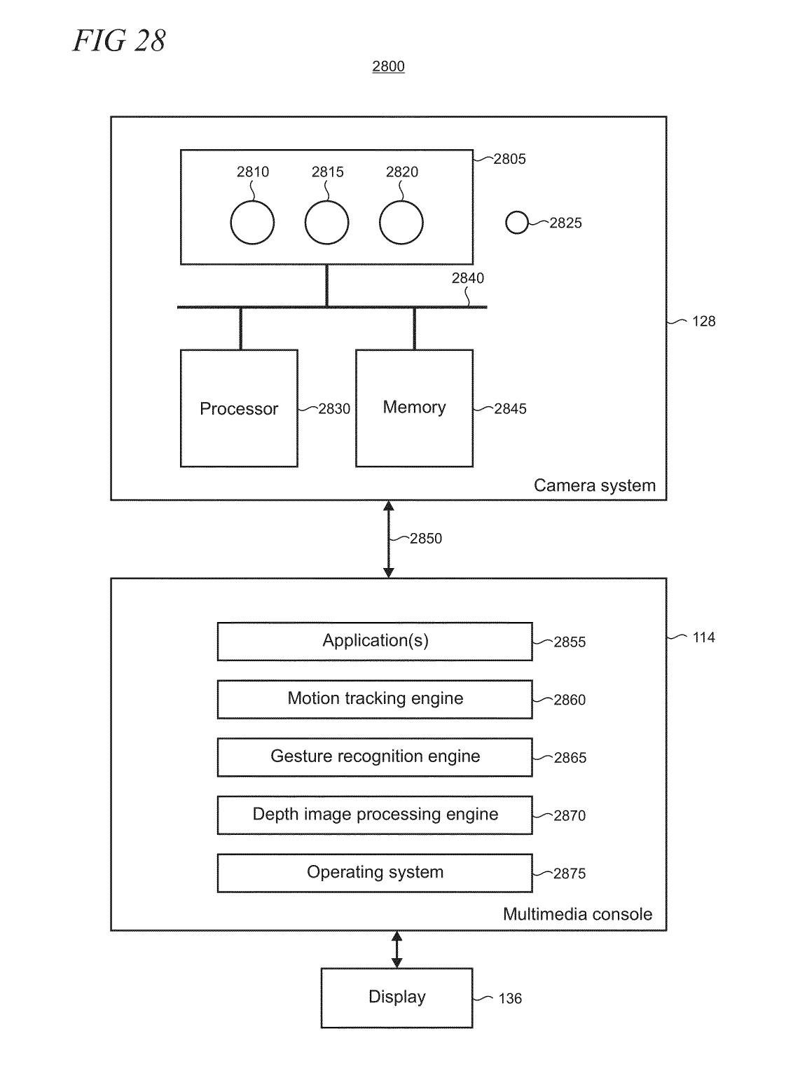

FIG. 28 shows illustrative functional components of the camera system 128 that may be used as part of a target recognition, analysis, and tracking system 2800 to recognize human and non-human targets in a capture area of a physical space monitored by the camera system without the use of special sensing devices attached to the subjects, uniquely identify them, and track them in three-dimensional space. The camera system 128 may be configured to capture video with depth information including a depth image that may include depth values via any suitable technique including, for example, time-of-flight, structured light, stereo image, or the like. In some implementations, the camera system 128 may organize the calculated depth information into “Z layers,” or layers that may be perpendicular to a Z-axis extending from the depth camera along its line of sight.

As shown in FIG. 28, the camera system 128 includes an image camera component 2805. The image camera component 2805 may be configured to operate as a depth camera that may capture a depth image of a scene. The depth image may include a two-dimensional (“2D”) pixel area of the captured scene where each pixel in the 2D pixel area may represent a depth value such as a distance in, for example, centimeters, millimeters, or the like of an object in the captured scene from the camera. In this example, the image camera component 2805 includes an IR light component 2810, an IR camera 2815, and a visible light RGB camera 2820 that may be configured in an array, as shown, or in an alternative geometry.

Various techniques may be utilized to capture depth video frames. For example, in time-of-flight analysis, the IR light component 2810 of the camera system 128 may emit an infrared light onto the capture area and may then detect the backscattered light from the surface of one or more targets and objects in the capture area using, for example, the IR camera 2815 and/or the RGB camera 2820. In some embodiments, pulsed infrared light may be used such that the time between an outgoing light pulse and a corresponding incoming light pulse may be measured and used to determine a physical distance from the camera system 128 to a particular location on the targets or objects in the capture area. Additionally, the phase of the outgoing light wave may be compared to the phase of the incoming light wave to determine a phase shift. The phase shift may then be used to determine a physical distance from the camera system to a particular location on the targets or objects. Time-of-flight analysis may be used to indirectly determine a physical distance from the camera system 128 to a particular location on the targets or objects by analyzing the intensity of the reflected beam of light over time via various techniques including, for example, shuttered light pulse imaging.

In other implementations, the camera system 128 may use structured light to capture depth information. In such an analysis, patterned light (i.e., light displayed as a known pattern such as a grid pattern or a stripe pattern) may be projected onto the capture area via, for example, the IR light component 2810. Upon striking the surface of one or more targets or objects in the capture area, the pattern may become deformed in response. Such a deformation of the pattern may be captured by, for example, the IR camera 2815 and/or the RGB camera 2820 and may then be analyzed to determine a physical distance from the camera system to a particular location on the targets or objects.

The camera system 128 may utilize two or more physically separated cameras that may view a capture area from different angles, to obtain visual stereo data that may be resolved to generate depth information. Other types of depth image arrangements using single or multiple cameras can also be used to create a depth image. The camera system 128 may further include a microphone 2825. The microphone 2825 may include a transducer or sensor that may receive and convert sound into an electrical signal. The microphone 2825 may be used to reduce feedback between the camera system 128 and the multimedia console 114 in the target recognition, analysis, and tracking system 2800. Additionally, the microphone 2825 may be used to receive audio signals that may also be provided by the user 112 to control applications such as game applications, non-game applications, or the like that may be executed by the multimedia console 114.

The camera system 128 may further include a processor 2830 that may be in operative communication with the image camera component 2805 over a bus 2840. The processor 2830 may include a standardized processor, a specialized processor, a microprocessor, or the like that may execute instructions that may include instructions for storing profiles, receiving the depth image, determining whether a suitable target may be included in the depth image, converting the suitable target into a skeletal representation or model of the target, or any other suitable instruction. The camera system 128 may further include a memory component 2845 that may store the instructions that may be executed by the processor 2830, images or frames of images captured by the cameras, user profiles or any other suitable information, images, or the like. According to one example, the memory component 2845 may include RAM, ROM, cache, Flash memory, a hard disk, or any other suitable storage component. As shown in FIG. 28, the memory component 2845 may be a separate component in communication with the image capture component 2805 and the processor 2830. Alternatively, the memory component 2845 may be integrated into the processor 2830 and/or the image capture component 2805. In one embodiment, some or all of the components 2805, 2810, 2815, 2820, 2825, 2830, 2835, 2840, and 2845 of the camera system 128 are located in a single housing.

The camera system 128 operatively communicates with the multimedia console 114 over a communication link 2850. The communication link 2850 may be a wired connection including, for example, a USB (Universal Serial Bus) connection, a Firewire connection, an Ethernet cable connection, or the like and/or a wireless connection such as a wireless IEEE 802.11 connection. The multimedia console 114 can provide a clock to the camera system 128 that may be used to determine when to capture, for example, a scene via the communication link 2845. The camera system 128 may provide the depth information and images captured by, for example, the IR camera 2815 and/or the RGB camera 2820, including a skeletal model and/or facial tracking model that may be generated by the camera system 128, to the multimedia console 114 via the communication link 2850. The multimedia console 114 may then use the skeletal and/or facial tracking models, depth information, and captured images to, for example, create a virtual screen, adapt the user interface, and control apps/games 2850. The apps/games 2855 may include the telestrator app 138 (FIG. 1).

A motion tracking engine 2860 uses the skeletal and/or facial tracking models and the depth information to provide a control output to one more apps/games 2855 running on the multimedia console 114 to which the camera system 128 is coupled. The information may also be used by a gesture recognition engine 2865, depth image processing engine 2870, and/or operating system 2875.

The depth image processing engine 2870 uses the depth images to track motion of objects, such as the user and other objects. The depth image processing engine 2870 will typically report to the operating system 2875 an identification of each object detected and the location of the object for each frame. The operating system 2875 can use that information to update the position or movement of an avatar, for example, or other images shown on the display 136, or to perform an action on the user interface.

The gesture recognition engine 2865 may utilize a gestures library (not shown) that can include a collection of gesture filters, each comprising information concerning a gesture that may be performed, for example, by a skeletal model (as the user moves). The gesture recognition engine 2865 may compare the frames captured by the camera system 114 in the form of the skeletal model and movements associated with it to the gesture filters in the gesture library to identify when a user (as represented by the skeletal model) has performed one or more gestures. Those gestures may be associated with various controls of an application and direct the system to open the personalized home screen as described above. Thus, the multimedia console 114 may employ the gestures library to interpret movements of the skeletal model and to control an operating system or an application running on the multimedia console based on the movements.

In some implementations, various aspects of the functionalities provided by the apps/games 2855, motion tracking engine 2860, gesture recognition engine 2865, depth image processing engine 2870, and/or operating system 2875 may be directly implemented on the camera system 128 itself.

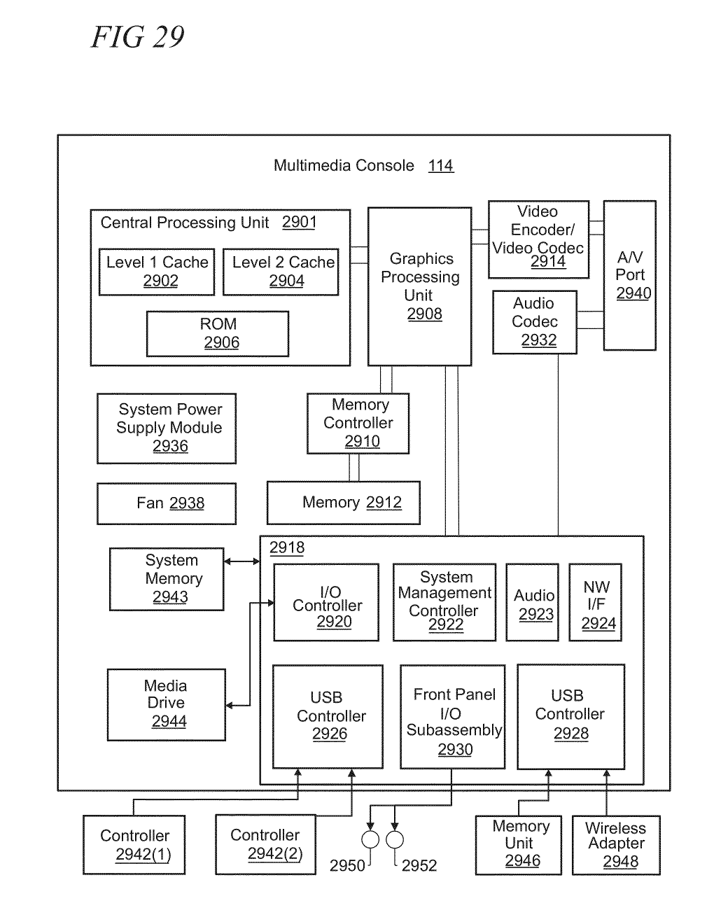

FIG. 29 is an illustrative functional block diagram of the multimedia console 114 shown in FIGS. 1 and 3-5. The multimedia console 114 has a central processing unit (CPU) 2901 having a level 1 cache 2902, a level 2 cache 2904, and a Flash ROM (Read Only Memory) 2906. The level 1 cache 2902 and the level 2 cache 2904 temporarily store data and hence reduce the number of memory access cycles, thereby improving processing speed and throughput. The CPU 2901 may be configured with more than one core, and thus, additional level 1 and level 2 caches 2902 and 2904. The Flash ROM 2906 may store executable code that is loaded during an initial phase of a boot process when the multimedia console 114 is powered ON.

A graphics processing unit (GPU) 2908 and a video encoder/video codec (coder/decoder) 2914 form a video processing pipeline for high speed and high resolution graphics processing. Data is carried from the GPU 2908 to the video encoder/video codec 2914 via a bus. The video processing pipeline outputs data to an A/V (audio/video) port 2940 for transmission to a television or other display. A memory controller 2910 is connected to the GPU 2908 to facilitate processor access to various types of memory 2912, such as, but not limited to, a RAM.

The multimedia console 114 includes an I/O controller 2920, a system management controller 2922, an audio processing unit 2923, a network interface controller 2924, a first USB (Universal Serial Bus) host controller 2926, a second USB controller 2928, and a front panel I/O subassembly 2930 that are preferably implemented on a module 2918. The USB controllers 2926 and 2928 serve as hosts for peripheral controllers 2942(1) and 2942(2), a wireless adapter 2948, and an external memory device 2946 (e.g., Flash memory, external CD/DVD ROM drive, removable media, etc.). The network interface controller 2924 and/or wireless adapter 2948 provide access to a network (e.g., the Internet, home network, etc.) and may be any of a wide variety of various wired or wireless adapter components including an Ethernet card, a modem, a Bluetooth module, a cable modem, or the like.

System memory 2943 is provided to store application data that is loaded during the boot process. A media drive 2944 is provided and may comprise a DVD/CD drive, hard drive, or other removable media drive, etc. The media drive 2944 may be internal or external to the multimedia console 114. Application data may be accessed via the media drive 2944 for execution, playback, etc. by the multimedia console 114. The media drive 2944 is connected to the I/O controller 2920 via a bus, such as a Serial ATA bus or other high speed connection (e.g., IEEE 1394).

The system management controller 2922 provides a variety of service functions related to assuring availability of the multimedia console 114. The audio processing unit 2923 and an audio codec 2932 form a corresponding audio processing pipeline with high fidelity and stereo processing. Audio data is carried between the audio processing unit 2923 and the audio codec 2932 via a communication link. The audio processing pipeline outputs data to the A/V port 2940 for reproduction by an external audio player or device having audio capabilities.

The front panel I/O subassembly 2930 supports the functionality of the power button 2950 and the eject button 2952, as well as any LEDs (light emitting diodes) or other indicators exposed on the outer surface of the multimedia console 114. A system power supply module 2936 provides power to the components of the multimedia console 114. A fan 2938 cools the circuitry within the multimedia console 114.

The CPU 2901, GPU 2908, memory controller 2910, and various other components within the multimedia console 114 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 114 is powered ON, application data may be loaded from the system memory 2943 into memory 2912 and/or caches 2902 and 2904 and executed on the CPU 2901. The application may present a graphical user interface that provides a consistent user experience when navigating to different media types available on the multimedia console 114. In operation, applications and/or other media contained within the media drive 2944 may be launched or played from the media drive 2944 to provide additional functionalities to the multimedia console 114.

The multimedia console 114 may be operated as a standalone system by simply connecting the system to a television or other display. In this standalone mode, the multimedia console 114 allows one or more users to interact with the system, watch movies, or listen to music. However, with the integration of broadband connectivity made available through the network interface controller 2924 or the wireless adapter 2948, the multimedia console 114 may further be operated as a participant in a larger network community.

When the multimedia console 114 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbps), etc. Because these resources are reserved at system boot time, the reserved resources do not exist from the application's view.

In particular, the memory reservation preferably is large enough to contain the launch kernel, concurrent system applications, and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render pop-ups into an overlay. The amount of memory needed for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV re-sync is eliminated.

After the multimedia console 114 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 2901 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 2942(1) and 2942(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches.

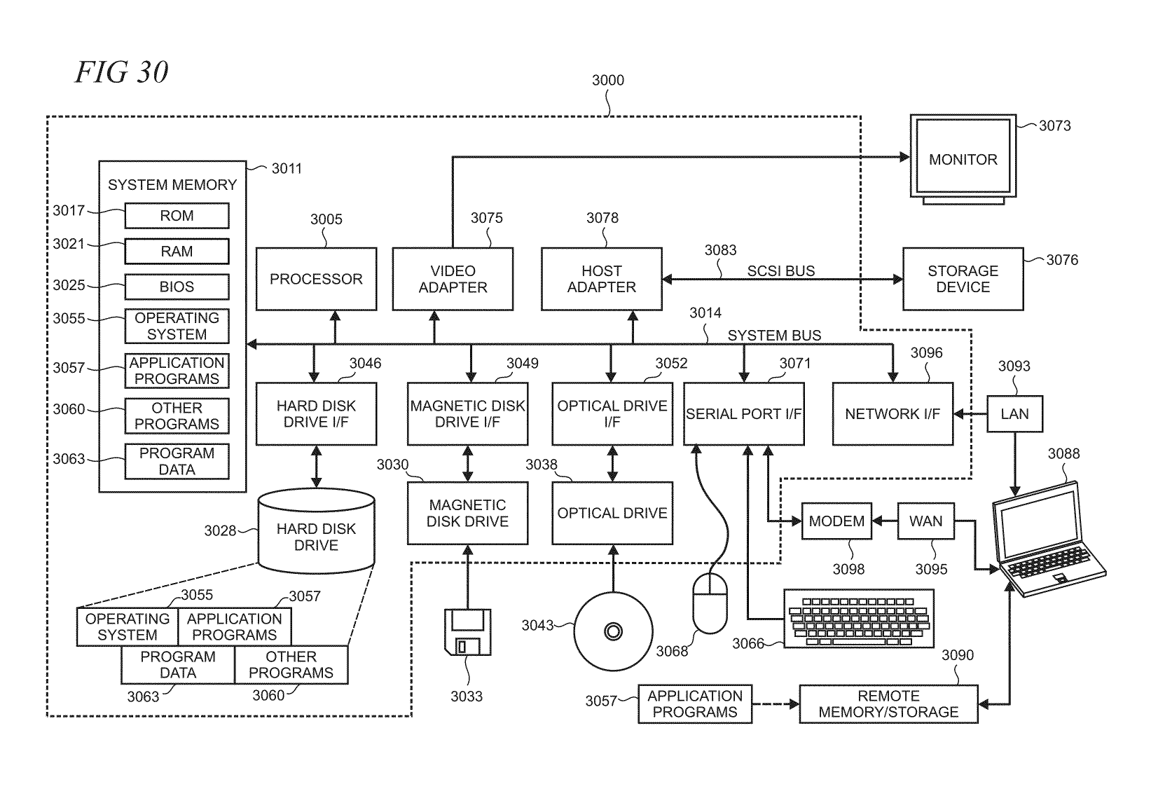

FIG. 30 is a simplified block diagram of an illustrative computer system 3000 such as a PC, client device, or server with which the present telestrator system may be implemented. Computer system 3000 includes a processing unit 3005, a system memory 3011, and a system bus 3014 that couples various system components including the system memory 3011 to the processing unit 3005. The system bus 3014 may be any of several types of bus structures including a memory bus or memory controller, a peripheral bus, and a local bus using any of a variety of bus architectures. The system memory 3011 includes read only memory (“ROM”) 3017 and random access memory (“RAM”) 3021. A basic input/output system (“BIOS”) 3025, containing the basic routines that help to transfer information between elements within the computer system 3000, such as during startup, is stored in ROM 3017. The computer system 3000 may further include a hard disk drive 3028 for reading from and writing to an internally disposed hard disk (not shown), a magnetic disk drive 3030 for reading from or writing to a removable magnetic disk 3033 (e.g., a floppy disk), and an optical disk drive 3038 for reading from or writing to a removable optical disk 3043 such as a CD (compact disc), DVD (digital versatile disc), or other optical media. The hard disk drive 3028, magnetic disk drive 3030, and optical disk drive 3038 are connected to the system bus 3014 by a hard disk drive interface 3046, a magnetic disk drive interface 3049, and an optical drive interface 3052, respectively. The drives and their associated computer readable storage media provide non-volatile storage of computer readable instructions, data structures, program modules, and other data for the computer system 3000. Although this illustrative example shows a hard disk, a removable magnetic disk 3033, and a removable optical disk 3043, other types of computer readable storage media which can store data that is accessible by a computer such as magnetic cassettes, flash memory cards, digital video disks, data cartridges, random access memories (“RAMs”), read only memories (“ROMs”), and the like may also be used in some applications of the present telestrator system. In addition, as used herein, the term computer readable storage medium includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk, magnetic disk 3033, optical disk 3043, ROM 3017, or RAM 3021, including an operating system 3055, one or more application programs 3057, other program modules 3060, and program data 3063. A user may enter commands and information into the computer system 3000 through input devices such as a keyboard 3066 and pointing device 3068 such as a mouse. Other input devices (not shown) may include a microphone, joystick, game pad, satellite dish, scanner, trackball, touchpad, touch screen, touch-sensitive module or device, gesture-recognition module or device, voice recognition module or device, voice command module or device, or the like. These and other input devices are often connected to the processing unit 3005 through a serial port interface 3071 that is coupled to the system bus 3014, but may be connected by other interfaces, such as a parallel port, game port, or USB. A monitor 3073 or other type of display device is also connected to the system bus 3014 via an interface, such as a video adapter 3075. In addition to the monitor 3073, personal computers typically include other peripheral output devices (not shown), such as speakers and printers. The illustrative example shown in FIG. 30 also includes a host adapter 3078, a Small Computer System Interface (“SCSI”) bus 3083, and an external storage device 3076 connected to the SCSI bus 3083.

The computer system 3000 is operable in a networked environment using logical connections to one or more remote computers, such as a remote computer 3088. The remote computer 3088 may be selected as another personal computer, a server, a router, a network PC, a peer device, or other common network node, and typically includes many or all of the elements described above relative to the computer system 3000, although only a single representative remote memory/storage device 3090 is shown in FIG. 30. The logical connections depicted in FIG. 30 include a local area network (“LAN”) 3093 and a wide area network (“WAN”) 3095. Such networking environments are often deployed, for example, in offices, enterprise-wide computer networks, intranets, and the Internet.

When used in a LAN networking environment, the computer system 3000 is connected to the local area network 3093 through a network interface or adapter 3096. When used in a WAN networking environment, the computer system 3000 typically includes a broadband modem 3098, network gateway, or other means for establishing communications over the wide area network 3095, such as the Internet. The broadband modem 3098, which may be internal or external, is connected to the system bus 3014 via a serial port interface 3071. In a networked environment, program modules related to the computer system 3000, or portions thereof, may be stored in the remote memory storage device 3090. It is noted that the network connections shown in FIG. 30 are illustrative and other means of establishing a communications link between the computers may be used depending on the specific requirements of an application of the present telestrator system. It may be desirable and/or advantageous to enable other types of computing platforms other than the multimedia console 114 to implement the present telestrator system in some applications.

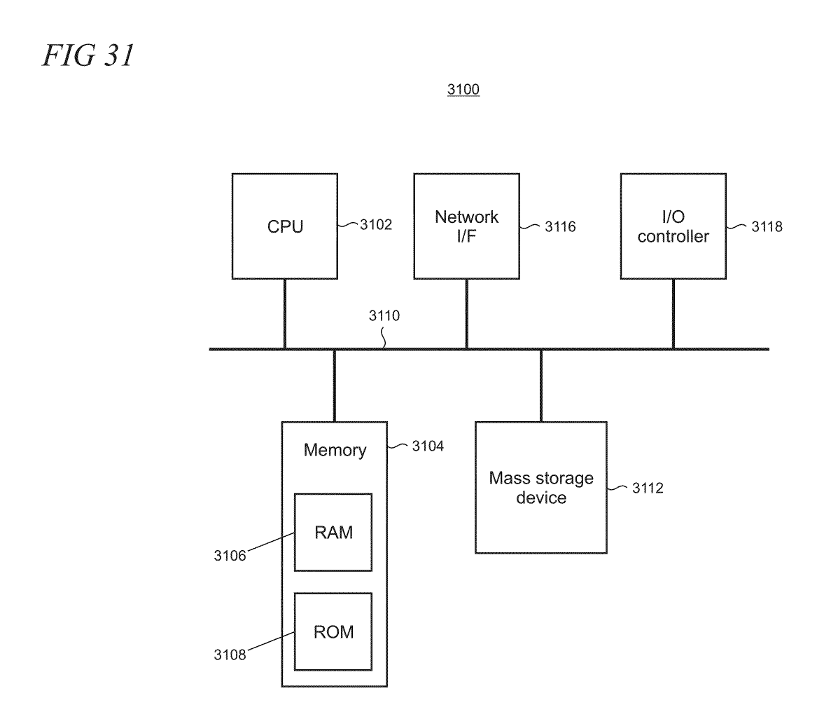

FIG. 31 shows an illustrative architecture 3100 for a computing platform or device capable of executing the various components described herein for the telestrator system. Thus, the architecture 3100 illustrated in FIG. 31 shows an architecture that may be adapted for a server computer, mobile phone, a PDA (personal digital assistant), a smartphone, a desktop computer, a netbook computer, a tablet computer, GPS (Global Positioning System) device, gaming console, and/or a laptop computer. The architecture 3100 may be utilized to execute any aspect of the components presented herein.

The architecture 3100 illustrated in FIG. 31 includes a CPU 3102, a system memory 3104, including a RAM 3106 and a ROM 3108, and a system bus 3110 that couples the memory 3104 to the CPU 3102. A basic input/output system containing the basic routines that help to transfer information between elements within the architecture 3100, such as during startup, is stored in the ROM 3108. The architecture 3100 further includes a mass storage device 3112 for storing software code or other computer-executed code that is utilized to implement applications, the file system, and the operating system.

The mass storage device 3112 is connected to the CPU 3102 through a mass storage controller (not shown) connected to the bus 3110. The mass storage device 3112 and its associated computer-readable storage media provide non-volatile storage for the architecture 3100. Although the description of computer-readable storage media contained herein refers to a mass storage device, such as a hard disk or CD-ROM drive, it should be appreciated by those skilled in the art that computer-readable media can be any available computer storage media that can be accessed by the architecture 3100.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), BLU-RAY, or other optical storage, magnetic cassettes, magnetic tape, magnetic disk storage or other magnetic storage devices, or any other medium which can be used to store the desired information and which can be accessed by the architecture 3100.

According to various embodiments, the architecture 3100 may operate in a networked environment using logical connections to remote computers through a network. The architecture 3100 may connect to the network through a network interface unit 3116 connected to the bus 3110. It should be appreciated that the network interface unit 3116 also may be utilized to connect to other types of networks and remote computer systems. The architecture 3100 also may include an input/output controller 3118 for receiving and processing input from a number of other devices, including a keyboard, mouse, or electronic stylus (not shown in FIG. 31). Similarly, the input/output controller 3118 may provide output to a display screen, a printer, or other type of output device (also not shown in FIG. 31).

It should be appreciated that the software components described herein may, when loaded into the CPU 3102 and executed, transform the CPU 3102 and the overall architecture 3100 from a general-purpose computing system into a special-purpose computing system customized to facilitate the functionality presented herein. The CPU 3102 may be constructed from any number of transistors or other discrete circuit elements, which may individually or collectively assume any number of states. More specifically, the CPU 3102 may operate as a finite-state machine, in response to executable instructions contained within the software modules disclosed herein. These computer-executable instructions may transform the CPU 3102 by specifying how the CPU 3102 transitions between states, thereby transforming the transistors or other discrete hardware elements constituting the CPU 3102.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the architecture 3100 in order to store and execute the software components presented herein. It also should be appreciated that the architecture 3100 may include other types of computing devices, including hand-held computers, embedded computer systems, smartphones, PDAs, and other types of computing devices known to those skilled in the art. It is also contemplated that the architecture 3100 may not include all of the components shown in FIG. 31, may include other components that are not explicitly shown in FIG. 31, or may utilize an architecture completely different from that shown in FIG. 31.

Based on the foregoing, it should be appreciated that technologies for a telestrator system have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed:

1. In a computing device having a coupled camera system and audio capture device, a method comprising:
rendering a video clip on a user interface (“UI”) supported by the computing device;
capturing gestures made by a user using the camera system;
using the captured gestures as input to a drawing system executing on the computing device, the drawing system configured for generating, responsively to the input, a drawing comprising graphic objects displayed on a selected portion of the video clip on the UI;
capturing an audio track of commentary from the user using the audio capture device;
recording the drawing and the captured audio track to generate a telestrated user experience.

2. The method of claim 1 further comprising exposing a video scrubbing capability to the user for selecting the portion of the video clip onto which the drawing is displayed using a gesture captured by the camera system.

3. The method of claim 2 in which the selected portion of the video clip comprises a still image.

4. The method of claim 1 further comprising exposing a color selection capability to the user for selecting a marker color for drawing a graphic object using a gesture captured by the camera system or using a voice command captured by the audio capture device.

5. The method of claim 1 further comprising exposing an undo capability to the user for undoing a last drawing stroke or for successively undoing multiple drawing strokes made from last to first.

6. The method of claim 1 further comprising exposing a clear capability to the user for clearing all the drawn graphic objects from the selected portion of the video clip.

7. The method of claim 1 further comprising exposing a recording control to the user to start or stop the recording.

8. The method of claim 1 further comprising receiving the video clip from an IPTV (Internet Protocol Television) provider.

9. The method of claim 1 further comprising receiving a voice command from the user using the audio capture device and changing the drawing in response to the voice command.

10. One or more computer-readable memories containing instructions which, when executed by one or more processors disposed in an electronic device having an associated user interface (“UI”), generate a telestrated user experience, the drawing system comprising:
exposing a telestrator mode launch control in the UI that initiates a telestration session when activated by a user;
providing drawing tools to the user for telestrating a video clip displayed on the UI during the telestration session, the drawing tools being configured to draw graphic objects on the video clip in the UI responsively to user gestures captured by a camera that is operatively coupled to the electronic device; and
recording the telestration session.

11. The one or more computer-readable memories of claim 10 further comprising exposing the telestrator mode launch control in a UI exposed by an application that is executing on the device or in an application launch window, menu, or dialogue supported on the device.

12. The one or more computer-readable memories of claim 10 further comprising applying shape recognition or smoothing to the drawn graphic objects, the graphic objects being one of lines, arrows, or shapes.

13. The one or more computer-readable memories of claim 10 further comprising beginning to draw a graphic object when the user makes a first gesture and ending the drawing of the graphic object when the user makes a second gesture.

14. The one or more computer-readable memories of claim 13 in which the first gesture includes pointing with a hand and the second gesture includes displaying an open palm of the hand.

15. The one or more computer-readable memories of claim 10 including exposing video controls to pause the video clip, start the video clip, and scrub the video clip along a video timeline.

16. A telestrator system, comprising:
one or more processors;
a camera system;
an audio capture device; and
one or more computer-readable memories storing instructions which, when executed by the one or more processors, implement the telestrator system for telestrating an image from a video clip displayed on a user interface (“UI”), the telestrator system comprising
a set of drawing tools that are user-selectable from the UI, the drawing tools being invocable by a user for telestrating the image using drawn lines, arrows, or shapes, the drawing being controlled using hand
gestures performed by the user that are captured by the camera system, a video scrubbing capability to enable the user to navigate to the image in the video clip using a hand gesture,
a voice commentary capability using the audio capture device for recording voice commentary in an audio track to accompany the telestrating of the image, and
a save capability for saving a telestrated user experience comprising a video recording showing the telestrating of the image and the accompanying audio track of voice commentary.

17. The telestrator system of claim 16 in which the hand gesture includes one of an open palm gesture, a closed fist gesture, or a lasso gesture, the lasso gesture using a pointing hand pose comprising at least dropping of a ring and pinky finger.

18. The telestrator system of claim 16 further comprising a share capability to share the telestrated user experience with one or more remote users over a network connection.

19. The telestrator system of claim 16 in which the drawing tools comprise a marker that can draw in different colors selected by the user.

20. The telestrator system of claim 16 in which the audio capture device is one of a microphone integrated into the camera system or a microphone disposed in a headset that is operatively coupled to the telestrator system.
